(19) United States
(12) Patent Application Publication
(10) Pub. No.: US 2026/0079417 A1
(43) Pub. Date: Mar. 19, 2026

(54) TONER

(71) Applicant: CANON KABUSHIKI KAISHA, Tokyo (JP)

(72) Inventors: KOKI INOUE, Shizuoka (JP); KENJI AOKI, Shizuoka (JP); SHUHEI IWASAKI, Kanagawa (JP); YUKI MASUDA, Shizuoka (JP); KAHO YAMADA, Shizuoka (JP)

(21) Appl. No.: 19/318,772

(22) Filed: Sep. 4, 2025

(30) Foreign Application Priority Data
Sep. 13, 2024 (JP) 2024-159095

(51) Int. Cl. G03G 9/087; C09D 125/08; G03G 9/093

(52) U.S. Cl. CPC G03G 9/08711; C09D 125/08; G03G 9/08755; G03G 9/09321; G03G 9/09328

(57) ABSTRACT

A toner comprising a toner particle, wherein the toner particle comprises a binder resin and an aliphatic alcohol, the binder resin comprises a crystalline vinyl resin and an amorphous vinyl resin, the crystalline vinyl resin comprises a specific monomer unit (a), the amorphous vinyl resin comprises a specific monomer unit (b), the aliphatic alcohol is a specific compound, and the toner particle comprises 100 to 10,000 ppm of the aliphatic alcohol based on a mass of the binder resin.

### BACKGROUND

### Field of the Technology

The present disclosure relates to a toner.

### Description of the Related Art

Conventionally, energy saving has been considered as a major technical issue in electrophotographic devices, and ways of significantly reducing the amount of heat applied to fixing devices are being investigated. There is an increasing need for toners that can be fixed with low energy, so-called “low-temperature fixability.”

As a method enabling low-temperature fixation, a method using a crystalline resin as a binder resin is being investigated. An amorphous resin that is generally used as a toner binder resin does not exhibit a clear endothermic peak in differential scanning calorimeter (DSC) measurement, but if the toner comprises a crystalline resin component, an endothermic peak (melting point) appears in DSC measurement.

Crystalline resins have regularly arranged molecular chains and thus have a property of minimal softening at temperatures lower than the melting point. In addition, when the melting point is exceeded, crystals rapidly melt, and accordingly, a rapid viscosity decrease is caused. Crystalline resins having an excellent sharp melt property in this manner are being focused on as materials useful for improving low-temperature fixability of the toner.

Toners using a crystalline vinyl resin having long-chain alkyl groups in the side chains in the molecule as a crystalline resin may be exemplified. Generally, crystalline vinyl resins have a structure in which long-chain alkyl groups are bonded to the main chain as side chains, the long-chain alkyl groups in the side chains crystallize with each other to form a lamella structure in which the molecules are regularly arranged, and thereby crystalline resins are formed.

Crystalline resins have excellent low-temperature fixability, but their viscosity excessively decreases when the melting point is exceeded. Therefore, there is a problem that the binder resin that melts during fixing cannot be released from a fixing member, internal separation occurs within the toner, and an image is formed on the second and subsequent rotations of the fixing roller, that is, so-called hot offset is likely to occur. In addition, even if hot offset does not occur, the binder resin may be stretched due to an excessive decrease in viscosity during melting, and thus fine unevennesses may occur in the fixed image and the gloss of the image may decrease.

Japanese Patent Publication No. 2022-162968 discloses a toner in which due to a crystalline resin being comprised, excellent low-temperature fixability is exhibited and in which the proportions of components with low polarity such as long-chain alkyl groups and components with high polarity in the crystalline resin are controlled in order to achieve both scratch resistance and charge stability.

The toner disclosed in Japanese Patent Publication No. 2022-162968 comprises amorphous parts with high polarity in a part of the crystalline resin, which do not contribute to crystallization, but it comprises a crystalline part and an amorphous part in the same molecule, and thus a rapid decrease in viscosity due to melting of the crystalline part cannot be reduced, and the issues of hot offset and gloss decrease still remain.

On the other hand, Japanese Patent Publication No. 2024-001609 discloses a toner using a crystalline resin, in which the ratio of the loss modulus G″ to the storage modulus G′ at a specific temperature is controlled by adding an amorphous resin. In the toner, since a crystalline resin and an amorphous resin that can maintain a certain viscosity after the crystalline resin melts are used in combination, it is possible to reduce a decrease in gloss uniformity of the fixed image caused by hot offset, separation of the binder resin after melting, and stretching of the resin during melting.

However, it has been found that, when the toner disclosed in Japanese Patent Publication No. 2024-001609 is used to continuously print on small size paper, as the number of print sheets increases, the number of fine unevennesses in the image on both the left and right ends of the paper increases, and the uniformity of gloss in the same image decreases (the gloss stability decreases). This is thought to be because, when small size paper is continuously printed on, since a decrease in temperature due to paper feeding does not occur in the part of the fixing member where the paper does not feed, the temperature at both ends of the paper increases excessively as the number of print sheets increases.

### SUMMARY

The present disclosure provides a toner that achieves low-temperature fixability, hot offset resistance and gloss stability in the same image when small size paper is continuously printed on, and also has excellent bending resistance and heat-resistant storability.

At least one aspect of the present disclosure is to provide a toner comprising a toner particle,
wherein the toner particle comprises a binder resin and an aliphatic alcohol,
the binder resin comprises a crystalline vinyl resin and an amorphous vinyl resin,
the crystalline vinyl resin comprises a monomer unit (a) represented by following Formula (1),
the amorphous vinyl resin comprises a monomer unit (b) represented by following Formula (2),
the aliphatic alcohol is a compound represented by following Formula (3), and
the toner particle comprises 100 to 10,000 ppm of the aliphatic alcohol based on a mass of the binder resin.

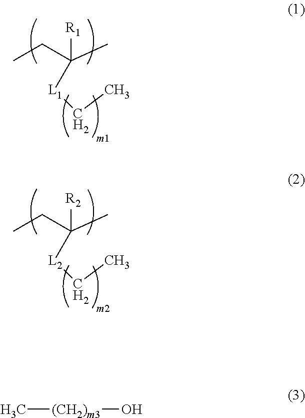

In Formula (1), R₁ represents a hydrogen atom or a methyl group, L₁ represents a single bond, an ester bond or an amide bond, and m1 represents an integer of 15 to 29.

In Formula (2), R₂ represents a hydrogen atom or a methyl group, L₂ represents a single bond, an ester bond or an amide bond, and m2 represents an integer of 0 to 13.

In Formula (3), m3 represents an integer of 15 to 29.

According to the present disclosure, it is possible to provide a toner that achieves low-temperature fixability, hot offset resistance and gloss stability in the same image when small size paper is continuously printed on, and also has excellent bending resistance and heat-resistant storability.

Features of the present disclosure will become apparent from the following description of embodiments. The following description of embodiments is described by way of example.

### DESCRIPTION OF THE EMBODIMENTS

In the present disclosure, the expression of “from XX to YY” or “XX to YY” indicating a numerical range means a numerical range including a lower limit and an upper limit which are end points, unless otherwise specified. Also, when a numerical range is described in a stepwise manner, the upper and lower limits of each numerical range can be arbitrarily combined. In the present disclosure, for example, descriptions such as “at least one selected from the group consisting of XX, YY and ZZ” mean any of XX, YY, ZZ, the combination of XX and YY, the combination of XX and ZZ, the combination of YY and ZZ, and the combination of XX, YY, and ZZ. Here, when XX is a group, a plurality of XXs may be selected, and the same applies to YY and ZZ.

The (meth)acrylic acid ester means an acrylic acid ester and/or a methacrylic acid ester.

The “monomer unit” refers to the reacted form of a monomer substance in a polymer. For example, one carbon-carbon bond section in the main chain in the polymer in which the polymerizable monomer has been polymerized is defined as one unit. The polymerizable monomer can be represented by the following formula (C).

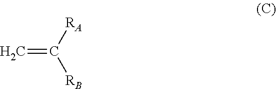

In the formula (C), R_{A} represents a hydrogen atom or an alkyl group (preferably an alkyl group having from 1 to 3 carbon atoms, and more preferably a methyl group), and R_{B} represents an arbitrary substituent.

The “crystalline resin” is a resin that exhibits a clear endothermic peak in differential scanning calorimeter (DSC) measurement.

The “endothermic peak” is a peak that is characterized by a minimum value on a differential curve of a DSC endothermic curve during heating in differential scanning calorimetry.

The following factors are thought to be responsible for fine unevennesses of the image on both the left and right ends of the above paper. In the toner disclosed in Japanese Patent Publication No. 2024-001609, since the bonding between the crystalline resin and the amorphous resin is insufficient, low-viscosity areas due to the crystalline resin are generated in the fixed image, which may result in insufficient release from the fixing member, and cause the fixed image to be stretched upward. Subsequently, when cooling, the amorphous resin, which exhibits a low solidification speed, is gradually absorbed onto the surface of the fixed image while maintaining its flexibility, but the crystalline resin, which exhibits a high solidification speed, immediately loses its flowability above the lifted fixed image, and is left above as a protruded portion. This is thought to result in formation of fine unevennesses.

The inventors investigated ways to improve the bond between the crystalline resin and the amorphous resin and to curb formation of parts in the binder resin where the solidification speed due to the crystalline resin is particularly high during fixing. Accordingly, the inventors found that, in a toner comprising a crystalline vinyl resin and an amorphous vinyl resin, it is possible to quickly bond parts of the crystalline resin and the amorphous resin using an aliphatic alcohol during fixing. As a result, the formation of protruded portions in the image caused by a high solidification speed of the crystalline resin during fixing can be curbed.

The present disclosure relates to a toner comprising a toner particle,
wherein the toner particle comprises a binder resin and an aliphatic alcohol,
the binder resin comprises a crystalline vinyl resin and an amorphous vinyl resin,
the crystalline vinyl resin comprises a monomer unit (a) represented by the following Formula (1),
the amorphous vinyl resin comprises a monomer unit (b) represented by the following Formula (2),
the aliphatic alcohol is a compound represented by following Formula (3), and
the toner particle comprises 100 to 10,000 ppm of the aliphatic alcohol based on a mass of the binder resin.

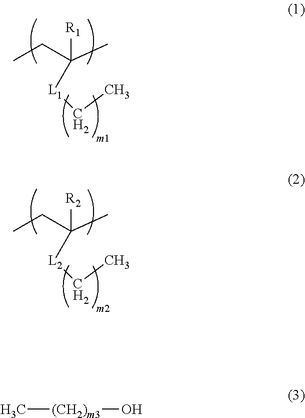

In Formula (1), R₁ represents a hydrogen atom or a methyl group, L₁ represents a single bond, an ester bond or an amide bond, and m1 represents an integer of 15 to 29.

In Formula (2), R₂ represents a hydrogen atom or a methyl group, L₂ represents a single bond, an ester bond or an amide bond, and m2 represents an integer of 0 to 13.

In Formula (3), m3 represents an integer of 15 to 29.

The toner according to the present disclosure comprises a toner particle comprising a binder resin. Here, the binder resin comprises a crystalline vinyl resin and an amorphous vinyl resin.

When the toner particle comprises a crystalline vinyl resin as a binder resin, since a rapid decrease in viscosity occurs during melting, a sharp melt property is exhibited and the low-temperature fixability is improved. In addition, since an excessive decrease in viscosity during melting can be reduced when the toner particle comprises an amorphous vinyl resin, the hot offset resistance is improved because the molten resin can be prevented from being separated and adhering to the fixing member.

In addition, in the toner according to the present disclosure, the crystalline vinyl resin comprises a monomer unit (a) represented by Formula (1), and the amorphous vinyl resin comprises a monomer unit (b) represented by Formula (2). In addition, the toner particle comprises an aliphatic alcohol. With such a configuration, when small size paper is continuously printed on, the gloss stability is improved. The inventors speculate the following reason for the mechanism.

When the crystalline vinyl resin melts during fixing, if the crystalline vinyl resin comprises a monomer unit (a), the long-chain alkyl group in the monomer unit (a) and the long-chain alkyl group of the aliphatic alcohol are attracted to each other by van der Waals forces, and the crystalline vinyl resin and the aliphatic alcohol interact appropriately. In addition, when the amorphous vinyl resin comprises a monomer unit (b) represented by Formula (2), the alkyl group in the monomer unit (b) and the long-chain alkyl group of the aliphatic alcohol are attracted to each other by van der Waals forces, and the amorphous vinyl resin and the aliphatic alcohol also interact appropriately.

In addition, because aliphatic alcohols have hydroxy groups in the molecules, they exhibit weak hydrogen bonds between two molecules. Therefore, weak hydrogen bonds are formed between an aliphatic alcohol that has interacted with a crystalline vinyl resin and another aliphatic alcohol that has interacted with an amorphous vinyl resin, and as a result, a structure in which the crystalline vinyl resin and the amorphous vinyl resin are appropriately bonded together with two aliphatic alcohol molecules is formed. In the case of such a structure, when the binder resin melts during fixing and then solidifies, the crystalline vinyl resin is bonded to the amorphous vinyl resin, which solidifies slowly and remains flowable, at the molecular level with an appropriate force.

As a result, it is estimated that the resin that is lifted toward the fixing member during melting is prevented from rapidly solidifying in the lifted state and forming a protruded portion due to a high solidification speed of the crystalline vinyl resin during cooling. As a result, when the temperature of the fixing roller end becomes particularly high during continuous paper feeding of small size paper such as A5, the temperature of the paper end near the fixing roller end whose temperature is already high, becomes particularly high, and even if the viscosity of the binder resin drops significantly, it is possible to reduce the occurrence of unevenness at the paper end. As a result, the gloss stability can be improved.

The above effect is particularly pronounced when using aliphatic alcohols among compounds having long-chain alkyl groups and exhibiting hydrogen bonding. The reason for this is that, for example, when fatty acids are used, since the hydrogen bonds of the fatty acids are much stronger than the hydrogen bonds of alcohol molecules, the fatty acids themselves tend to form dimers, and the fatty acids tend to aggregate together. Therefore, they are less likely to move quickly between the crystalline vinyl resin and the amorphous vinyl resin during melting, and it is thought that the above effect may not be achieved.

In addition, in the case of ester wax, it is thought that, due to strong cohesive forces between wax molecules, it is difficult for the wax to move to the site of action, as in the case of fatty acids, and furthermore, during fixing, the wax moves to the surface of the image and acts as a mold release agent, and thus the action observed with the aliphatic alcohol is not achieved.

In the toner according to the present disclosure, the crystalline vinyl resin comprises a monomer unit (a) represented by following Formula (1).

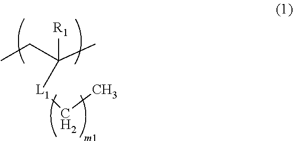

In Formula (1), R₁ represents a hydrogen atom or a methyl group, L₁ represents a single bond, an ester bond or an amide bond, and m1 represents an integer of 15 to 29. L₁ is preferably an ester bond, and the carbonyl group in the ester bond is preferably bonded to a carbon atom to which R₁ is bonded.

When m1 is 15 or more, the effect of gloss stability is obtained, the melting point of crystals increases, and heat-resistant storability is improved. In addition, when m1 is 29 or less, the viscosity is less likely to increase during melting, and low-temperature fixability is improved. m1 is preferably 17 to 29, and more preferably 19 to 24.

When the amorphous vinyl resin comprises a plurality of monomer units (a) represented by Formula (1), the value of m1 is determined as a weighted average weighed by the mass proportion of each monomer unit. When the value of m1 is not an integer, the value rounded off to the first decimal place is used.

In addition, the amorphous vinyl resin comprises a monomer unit (b) represented by following Formula (2).

When the rigidity derived from the amorphous vinyl resin is improved, the bending resistance is improved.

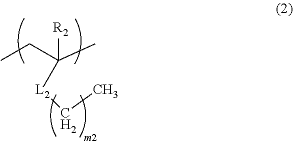

In Formula (2), R₂ represents a hydrogen atom or a methyl group, and L₂ represents a single bond, an ester bond or an amide bond. m2 represents an integer of 0 to 13. m2 is preferably an integer of 3 to 13, and more preferably an integer of 3 to 12. L₂ is preferably an ester bond, and the carbonyl group in the ester bond is preferably bonded to a carbon atom to which R₂ is bonded.

When m2 is 0 or more, the alkyl group interacts with the aliphatic alcohol, and the gloss stability is improved. When m2 is 3 or more, the interaction between the alkyl group and the aliphatic alcohol becomes stronger, and the gloss stability improvement effect becomes stronger. In addition, when m2 exceeds 13, the interaction between the alkyl group and the aliphatic alcohol becomes excessively strong, the aliphatic alcohol is prevented from moving to the site of action for contributing to the gloss stability, and thus the gloss stability may decrease.

When the amorphous vinyl resin comprises a plurality of monomer units (b) represented by Formula (2), the value of m2 is determined as a weighted average weighed by the mass proportion of each unit. When the value of m2 is not an integer, the value rounded off to the first decimal place is used.

The toner particle comprises an aliphatic alcohol. The aliphatic alcohol is a compound represented by the following Formula (3).

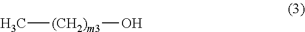

In Formula (3), m3 represents an integer of 15 to 29.

When m3 is 15 or more, the interaction between the aliphatic alcohol and the crystalline vinyl resin and the amorphous vinyl resin becomes sufficiently large, and the gloss stability is improved. When m3 is 29 or less, the interaction between the aliphatic alcohols due to van der Waals forces does not become too strong, aggregation between the aliphatic alcohols can be curbed, and thus the aliphatic alcohols quickly move to the site where they are desired to act as anchors. Therefore, the gloss stability improvement effect is obtained. m3 is preferably 17 to 26, and more preferably 19 to 24.

When the toner particle comprises a plurality of aliphatic alcohols represented by Formula (3), the value of m3 is determined as a weighted average weighed by each mass proportion. When the value of m3 is not an integer, the value rounded off to the first decimal place is used.

Examples of aliphatic alcohols represented by Formula (3) include cetanol, octadecanol, 1-eicosanol, behenyl alcohol, 1-tetracosanol, 1-hexacosanol, and myricyl alcohol.

For m1 in Formula (1) and m3 in Formula (3), the value of |m1-m3| is, for example, 0 to 8, or 0 to 4. m1 in Formula (1) and m3 in Formula (3) preferably satisfy the following Formula (4).

$$\vert m 1 - m 3 \vert \leq 2 \qquad ( 4 )$$

When m1 and m3 satisfy Formula (4), since the carbon chain lengths of the crystalline vinyl resin and the aliphatic alcohol become sufficiently short, a strong interaction is exhibited. Therefore, the gloss stability is further improved. The value of |m1-m3| is more preferably 0 to 1, and still more preferably 0.

For m2 in Formula (2) and m3 in Formula (3), the value of |m2-m3| is, for example, 4 to 26. m2 in Formula (2) and m3 in Formula (3) preferably satisfy the following Formula (5).

$$\vert m 2 - m 3 \vert \geq 6 \qquad ( 5 )$$

When m2 and m3 satisfy Formula (5), the carbon chain lengths of the amorphous vinyl resin and the aliphatic alcohol do not become too short, and an appropriate level of interaction occurs. Therefore, the bond between the alcohol and the amorphous vinyl resin, which has a high melt viscosity and is difficult to move, does not become too strong, the alcohol easily moves to the location where it interacts with the crystalline vinyl resin, and the gloss stability is further improved.

The value of |m2-m3| is preferably 6 to 26, and more preferably 6 to 20.

In addition, the toner particle comprises 100 to 10,000 ppm of aliphatic alcohols based on the mass of the binder resin. When the toner particle comprises 100 ppm or more of aliphatic alcohols, the amount of the aliphatic alcohols that bind the crystalline vinyl resin and the amorphous vinyl resin becomes sufficient, and the gloss stability is improved. In addition, when the concentration of the aliphatic alcohol increases, the alkyl groups attract each other and tend to form multimers, but when the content of the aliphatic alcohol is 10,000 ppm or less, since aggregation of the alcohols can be curbed, and thus the gloss stability is improved.

The toner particle comprises preferably 100 to 6,000 ppm, more preferably 1,000 to 6,000 ppm, and still more preferably 3,000 to 6,000 ppm of aliphatic alcohols based on the mass of the binder resin.

When the toner particle comprises 1,000 ppm or more of the aliphatic alcohols, the amount of the aliphatic alcohols that bind the crystalline vinyl resin and the amorphous vinyl resin becomes more sufficient, and the gloss stability is further improved. In addition, when the toner particle comprises 3,000 ppm or more of the aliphatic alcohols, the amount of the aliphatic alcohols that bind the crystalline vinyl resin and the amorphous vinyl resin becomes more sufficient, and the gloss stability is further improved.

When the content of the aliphatic alcohol is 6,000 ppm or less, since aggregation of the alcohols can be further curbed, the gloss stability is further improved.

Hereinafter, a crystalline vinyl resin according to the present disclosure will be described.

The content of the crystalline vinyl resin based on the mass of the binder resin is, for example, 1.0 to 80.0 mass %, preferably 5.0 to 75.0 mass %, and more preferably 10.0 to 55.0 mass %.

When the content of the crystalline vinyl resin is 5.0 mass % or more, since the amount of crystalline components is sufficient, the sharp melt property of the crystalline resin is significantly exhibited. Therefore, the low-temperature fixability is further improved. In addition, when the content of the crystalline vinyl resin is 75.0 mass % or less, since an excessive amount of crystalline components is not comprised, the resin is less likely to be stretched and an excessive decrease in viscosity is less likely to occur, the gloss stability and the hot offset resistance are further improved.

When the content of the crystalline vinyl resin is 10.0 mass % or more, since the amount of crystalline components comprised is more sufficient, the sharp melt property of the crystalline resin is exhibited more significantly. In addition, when the content of the crystalline vinyl resin is 55.0 mass % or less, the resin is less likely to be stretched and an excessive decrease in viscosity is less likely to occur, and the gloss stability and hot offset are further improved.

The crystalline vinyl resin comprises a monomer unit (a) represented by the following Formula (1).

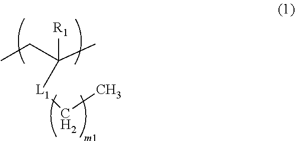

In Formula (1), R₁ represents a hydrogen atom or a methyl group, L₁ represents a single bond, an ester bond, or an amide bond, and m1 represents an integer of 15 to 29.

When L₁ is an ester bond, the monomer unit (a) can be incorporated as a monomer unit of a crystalline vinyl resin by performing vinyl polymerization using a (meth)acrylic acid alkyl ester having an alkyl group having 16 to 30 carbon atoms as a polymerizable monomer.

Examples of (meth)acrylic acid alkyl esters having an alkyl group having 16 to 30 carbon atoms include cetyl (meth)acrylate, stearyl (meth)acrylate, nonadecyl (meth)acrylate, eicosyl (meth)acrylate, heneicosanyl (meth)acrylate, behenyl (meth)acrylate, lignoceryl (meth)acrylate, ceryl (meth)acrylate, octacosyl (meth)acrylate, and myristyl (meth)acrylate.

Among these, in consideration of low-temperature fixability and heat-resistant storability of the toner, it is preferably at least one selected from the group consisting of (meth)acrylic acid esters having an alkyl group having 18 to 30 carbon atoms, and more preferably at least one selected from the group consisting of linear stearyl (meth)acrylates and behenyl (meth)acrylates. That is, in Formula (1), m1 is preferably 17 to 29, more preferably 19 to 24, and still more preferably 17 or 21. In addition, R₁ is preferably a hydrogen atom.

The crystalline vinyl resin may have only one type of the monomer unit (a) or may have two or more types thereof.

Examples of methods for introducing a crystalline vinyl resin into the monomer unit (a) include a method of polymerizing (meth)acrylic acid ester as follows. Examples thereof include stearyl (meth)acrylate, nonadecyl (meth)acrylate, eicosyl (meth)acrylate, heneicosanyl (meth)acrylate, behenyl (meth)acrylate, lignoceryl (meth)acrylate, ceryl (meth)acrylate, octacosyl (meth)acrylate, and myristyl (meth)acrylate.

The content of the monomer unit (a) represented by Formula (1) in the crystalline vinyl resin is, for example, 3.0 to 100.0 mass %, preferably 5.0 to 100.0 mass %, and more preferably 50.0 to 100.0 mass %. In addition, the content of the monomer unit (a) is the sum of the contents of all the monomer units represented by Formula (1), and the same applies when there are a plurality of types of monomer units (a).

When the content of the monomer unit (a) is 5.0 mass % or more, the amount of crystalline components in the crystalline vinyl resin is sufficiently large, and the sharp melt property of the crystalline resin is significantly exhibited. Therefore, the low-temperature fixability is further improved. In addition, when the content of the monomer unit (a) is 50.0 mass % or more, the amount of crystalline components in the crystalline vinyl resin becomes more sufficient, and the sharp melt property of the crystalline resin is exhibited more significantly. Therefore, the low-temperature fixability is further improved.

In addition to the monomer unit (a), the crystalline vinyl resin may comprise monomer units other than the monomer unit (a). Examples of methods for introducing other monomer units into the crystalline vinyl resin include a method of polymerizing a (meth)acrylic acid ester that forms the monomer unit (a) with other vinyl monomers.

Examples of other vinyl monomers include the following:

(Meth)acrylic acid esters such as styrene, α-methylstyrene, methyl (meth)acrylate, ethyl (meth)acrylate, n-butyl (meth)acrylate, t-butyl (meth)acrylate, and 2-ethylhexyl (meth)acrylate.

Monomers having a urea group: for example, monomers obtained by reacting an amine having 3 to 22 carbon atoms [primary amines (n-butylamine, t-butylamine, propylamine, isopropylamine, and so forth), secondary amines (di-n-ethylamine, di-n-propylamine, di-n-butylamine, and so forth), aniline, cycloxylamine, and so forth] with an isocyanate having 2 to 30 carbon atoms and an ethylenically unsaturated bond by a known method.

Monomers having a carboxy group; for example, methacrylic acid, acrylic acid, and 2-carboxyethyl (meth)acrylate.

Monomers having a hydroxy group; for example, 2-hydroxyethyl (meth)acrylate, 2-hydroxypropyl (meth)acrylate, and so forth

Monomers having an amide group; for example, acrylamide, and monomers obtained by reacting an amine having 1 to 30 carbon atoms with a carboxylic acid having 2 to 30 carbon atoms and having an ethylenically unsaturated bond (acrylic acid, methacrylic acid, and so forth) by a known method.

Monomers having a lactam structure; for example, N-vinyl-2-pyrrolidone.

In addition, the crystalline vinyl resin may comprise monomer units based on styrene. The crystalline vinyl resin comprises preferably 0.0 to 95.0 mass % and more preferably 0.0 to 45.0 mass % of the monomer units based on styrene.

In addition, the crystalline vinyl resin may comprise monomer units based on (meth)acrylonitrile. The crystalline vinyl resin comprises preferably 0.0 to 15.0 mass % and more preferably 0.0 to 12.0 mass % of the monomer units based on (meth)acrylonitrile.

In the crystalline vinyl resin, the weight-average molecular weight (Mw) of a tetrahydrofuran (THF)-soluble component measured by gel permeation chromatography (GPC) is preferably from 30,000 to 200,000. When the Mw is within this range, it is easier to adjust the melting point of the crystalline vinyl resin for exhibiting low-temperature fixability to be within an appropriate range. The Mw range is preferably from 40,000 to 180,000, and more preferably from 60,000 to 150,000.

The binder resin comprises an amorphous vinyl resin comprising a monomer unit (b) represented by following Formula (2).

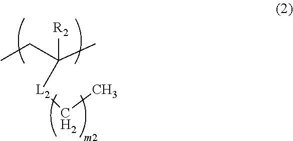

In Formula (2), R₂ represents a hydrogen atom or a methyl group, L₂ represents a single bond, an ester bond or an amide bond, and m2 represents an integer of 0 to 13.

The monomer unit (b) can be incorporated as a monomer unit of the amorphous vinyl resin by performing vinyl polymerization using a (meth)acrylic acid alkyl ester having an alkyl group having 1 to 14 carbon atoms as a polymerizable monomer.

Examples of (meth)acrylic acid alkyl esters having an alkyl group having 1 to 14 carbon atoms include
methyl (meth)acrylate, ethyl (meth)acrylate, n-butyl (meth)acrylate, dodecyl (meth)acrylate, and tetradecyl (meth)acrylate.

The content of the amorphous vinyl resin based on the mass of the binder resin is, for example, 20.0 to 96.0 mass %, preferably 25.0 to 95.0 mass %, and more preferably 40.0 to 90.0 mass %.

When the content of the amorphous vinyl resin is 25.0 mass % or more, since the number of alkyl groups that interact with the crystalline vinyl resin via the aliphatic alcohol becomes sufficient, the gloss stability is further improved. In addition, an excess decrease in melt viscosity can be further reduced. When the content of the amorphous vinyl resin is 95.0 mass % or less, a rapid decrease in viscosity during melting is not prevented, and the low-temperature fixability is further improved.

In addition, when the content of the amorphous vinyl resin is 40.0 mass % or more, since the number of alkyl groups that interact with the crystalline vinyl resin via the aliphatic alcohol becomes more sufficient, the gloss stability is further improved. In addition, an excess decrease in melt viscosity can be further reduced. When the content of the amorphous vinyl resin is 90.0 mass % or less, since a rapid decrease in viscosity during melting is less likely to be further inhibited, the low-temperature fixability is further improved.

The content of the monomer unit (b) in the amorphous vinyl resin is, for example, 10.0 to 85.0 mass %, preferably 18.0 to 80.0 mass %, more preferably 20.0 to 40.0 mass %, and still more preferably 22.0 to 40.0 mass %.

In addition to the monomer unit (b), the amorphous vinyl resin may comprise monomer units other than the monomer unit (b). Examples of methods for introducing other monomer units into the amorphous vinyl resin include a method of polymerizing a (meth)acrylic acid alkyl ester that forms the monomer unit (b) with other vinyl monomers.

As other vinyl monomers, for example, vinyl monomers that can be used in the crystalline vinyl resin can be used. These vinyl monomers can be used in a range in which the amorphous resin does not exhibit crystallinity.

As other vinyl monomers, highly amorphous styrene is preferably used, and based on the mass of the amorphous vinyl resin, the amorphous vinyl resin comprises, for example, 15.0 to 90.0 mass %, preferably 20.0 to 90.0 mass %, more preferably 60.0 to 85.0 mass %, and still more preferably 60.0 to 80.0 mass % of monomer units derived from styrene.

When the content of the styrene unit is 20.0 mass % or more, the amorphous property is improved, and even when the crystalline resin is used to improve the low-temperature fixability, the rigidity improvement effect derived from the amorphous resin becomes strong. In addition, since the styrene units have aromatic rings within the units, when π-π interactions are formed between the units, the rigidity improvement effect becomes stronger. As a result, the bending resistance is improved.

In addition, when the content of the styrene unit is 90.0 mass % or less, the content of the monomer units (b) that interact with an alcohol in the amorphous resin is sufficiently large, the monomer units (b) are uniformly present on the entire fixed image, and thus the gloss stability is further improved.

In addition, so-called crosslinking agents having a plurality of vinyl groups per monomer can also be used. Examples of crosslinking agents include the following:

Diethylene glycol diacrylate, triethylene glycol diacrylate, tetraethylene glycol diacrylate, polyethylene glycol diacrylate, 1,6-hexanediol diacrylate, neopentyl glycol diacrylate, tripropylene glycol diacrylate, polypropylene glycol diacrylate, 2,2′-bis(4-(acryloxydiethoxy)phenyl)propane, trimethylolpropane triacrylate, tetramethylolmethane tetraacrylate, ethylene glycol dimethacrylate, diethylene glycol dimethacrylate, triethylene glycol dimethacrylate, tetraethylene glycol dimethacrylate, polyethylene glycol dimethacrylate, 1,3-butylene glycol dimethacrylate, 1,6-hexanediol dimethacrylate, neopentyl glycol dimethacrylate, polypropylene glycol dimethacrylate, 2,2′-bis(4-(methacryloxydiethoxy)phenyl)propane, 2,2′-bis(4-(methacryloxypolyethoxy)phenyl)propane, trimethylolpropane trimethacrylate, tetramethylolmethane tetramethacrylate, divinylbenzene, divinylnaphthalene, divinyl ether, 4,4′-divinylbiphenyl, and the like.

In addition to the amorphous vinyl resin, the binder resin may comprise an amorphous resin other than the amorphous vinyl resin. Examples of other amorphous resins include polyester resins, polyurethane resins, and epoxy resins.

When the amorphous resin is a polyester resin, a polyester resin which is a reaction product of a divalent or higher valency carboxylic acid and a polyhydric alcohol can be used.

Examples of polyvalent carboxylic acids include the following:

Dibasic acids such as succinic acid, adipic acid, sebacic acid, phthalic acid, isophthalic acid, terephthalic acid, malonic acid, and dodecenyl succinic acid, anhydrides thereof or lower alkyl esters thereof, and aliphatic unsaturated dicarboxylic acids such as maleic acid, fumaric acid, itaconic acid and citraconic acid. 1,2,4-benzenetricarboxylic acid, 1,2,5-benzenetricarboxylic acid, anhydrides thereof or lower alkyl esters thereof. These may be used alone or two or more thereof may be used in combination.

Examples of polyhydric alcohols include the following:

Alkylene glycol (ethylene glycol, 1,2-propylene glycol and 1,3-propylene glycol); alkylene ether glycol (polyethylene glycol and polypropylene glycol); alicyclic diol (1,4-cyclohexanedimethanol); bisphenol (bisphenol A); alkylene oxides of alicyclic diols (ethylene oxide and propylene oxide) adducts. The alkyl moieties of alkylene glycol and alkylene ether glycol may be linear or branched. In addition, glycerin, trimethylolethane, trimethylolpropane, pentaerythritol and the like. These may be used alone or two or more thereof may be used in combination.

Here, in order to adjust the acid value and the hydroxyl value, as necessary, monovalent acids such as acetic acid and benzoic acid, and monovalent alcohols such as cyclohexanol and benzyl alcohol can also be used.

As the method of producing a polyester resin, for example, a transesterification method and a direct polycondensation method can be used alone or in combination.

The toner particle is preferably a toner particle having a core-shell structure comprising a core particle and a shell formed on a surface of the core particle. When the shell is provided, since adhesion to the fixing roller can be inhibited, upward stretching of the resin during fixing can be curbed, and the gloss stability is further improved.

In addition, since the aliphatic alcohol has hydroxyl groups, when the aliphatic alcohol is present on the surface of the toner, it may absorb water in air. In order to improve charge stability and reduce fogging, it is preferable that the toner particle have a shell. When the core is covered with the shell, since the exposure of the alcohol can be curbed, fogging is easily reduced. In addition, since a low-molecular-weight component inside of the core can be prevented from being exposed during storage in a high temperature and high humidity environment, the heat-resistant storability is further improved.

In addition, the shell is preferably an amorphous resin. When the shell is an amorphous resin, since an excessive decrease in viscosity of the surface of the toner during fixing is less likely to occur, the molten resin is less likely to be stretched upward, and the gloss stability is further improved.

In addition, the SP value of the amorphous resin of the shell is SP_{S} (J/cm³)^{0.5}, and the SP value of the crystalline vinyl resin is SP_{A} (J/cm³)^{0.5}. In this case, SP_{S}-SP_{A} is, for example, 0 to 5.5. It is preferable that SP_{S} and SP_{A} satisfy the following Formula (6).

$${SP}_{S} - {SP}_{A} \leq 5. \qquad ( 6 )$$

The fact that SP_{S} (J/cm³)^{0.5} and SP_{A} (J/cm³)^{0.5} satisfy Formula (6) indicates that the affinity between the amorphous resin of the shell and the crystalline vinyl resin is high. In this case, the interface between the core particle and the shell is likely to be stabilized, and the above effect obtained by covering the core with the shell is likely to be obtained. As a result, the gloss stability, charge stability, and heat-resistant storability are further improved. SP_{S}-SP_{A} is more preferably 0 to 2.0, and still more preferably 0 to 1.0.

SP_{S} (J/cm³)^{0.5} and SP_{A} (J/cm³)^{0.5} can be adjusted by changing the types of polymerizable monomers, polyvalent carboxylic acids, and polyhydric alcohols used to obtain the resins used in the shell and the core particle.

In consideration of charge stability, the amorphous resin in the shell is preferably a vinyl resin or a polyester resin. An amorphous polyester resin is more preferable. As the vinyl resin and polyester resin constituting the shell, vinyl resins and polyester resins which can be used for the above crystalline vinyl resin and amorphous resin can be used.

The shell does not necessarily cover the entire core particle, and some part of the core may be exposed. For example, the shell may cover the core particle to an extent that absorption of water by the aliphatic alcohol can be curbed.

The content of the shell in the toner particle is preferably 1.0 to 8.0 mass %, more preferably 2.0 to 6.0 mass %, and still more preferably 3.0 to 5.0 mass %.

The toner particle may comprise a wax. The wax is at least one selected from the group consisting of a hydrocarbon wax and an ester wax. When a hydrocarbon wax and/or an ester wax is used, it is easier to secure an effective release property.

Examples of hydrocarbon waxes include the following:

Aliphatic hydrocarbon waxes: low-molecular-weight polyethylene, low-molecular-weight polypropylene, low-molecular-weight olefin copolymers, Fischer-Tropsch wax, and waxes obtained by oxidizing or adding acids to these waxes.

The ester wax may be any wax having at least one ester bond in one molecule, and either a natural ester wax or a synthetic ester wax may also be used.

Examples of ester waxes include the following:
Esters of monohydric alcohols and monocarboxylic acids such as behenyl behenate, stearyl stearate, and palmityl palmitate;
Esters of divalent carboxylic acids and monoalcohols such as dibehenyl sebacate;
Esters of divalent alcohols and monocarboxylic acids such as ethylene glycol distearate and hexanediol dibehenate;
Esters of trihydric alcohols and monocarboxylic acids such as glycerin tribehenate;
Esters of tetrahydric alcohols and monocarboxylic acids such as pentaerythritol tetrastearate, and pentaerythritol tetrapalmitate;
Esters of hexahydric alcohols and monocarboxylic acids such as dipentaerythritol hexastearate, dipentaerythritol hexapalmitate, and dipentaerythritol hexabehenate;
Esters of polyfunctional alcohols and monocarboxylic acids such as polyglycerin behenate; and natural ester waxes such as carnauba wax and rice wax.

Among these, an ester wax with two or more functional groups is preferable. Particularly, an ester wax which is an ester of from a tetra- to octa valent alcohol and an aliphatic monocarboxylic acid or an ester wax which is an ester of from a tetra- to octa valent carboxylic acid or an aliphatic monoalcohol is more preferable. When such a wax is comprised, the compatibility with the crystalline vinyl resin during fixing is reduced, it is easier to improve the release property during fixing at low temperatures and it is easier to improve the low-temperature fixability.

In addition, the following esters are more preferable.

Esters of tetrahydric alcohols and monocarboxylic acids such as pentaerythritol tetrastearate, pentaerythritol tetrapalmitate, and pentaerythritol tetrabehenate, esters of hexahydric alcohols and monocarboxylic acids such as dipentaerythritol hexastearate, dipentaerythritol hexapalmitate, and dipentaerythritol hexabehenate, and esters of octahydric alcohols and monocarboxylic acids such as tripentaerythritol octastearate, tripentaerythritol octapalmitate, and tripentaerythritol octabehenate.

The content of the wax in the toner particle is preferably 1.0 to 30.0 mass %, and more preferably 2.0 to 25.0 mass %. When the content of the wax in the toner particle is within the above range, it is easier to secure a release property during fixing.

The melting point of the wax is preferably 60 to 120° C. When the melting point of the wax is within the above range, the wax melts during fixing and easily exudes onto the surface of the toner particle, and the release property of the wax is easily exhibited. The melting point of the wax is more preferably 70 to 100° C.

The toner particle may comprise a colorant. Examples of colorants include known organic pigments, organic dyes, inorganic pigments, carbon black as a black colorant, and magnetic particles. Other colorants that are conventionally used in toners may also be used.

Examples of yellow colorants include the following: Condensed azo compounds, isoindolinone compounds, anthraquinone compounds, azo metal complexes, methine compounds, and arylamide compounds. Among these, C.I. Pigment yellow 12, 13, 14, 15, 17, 62, 74, 83, 93, 94, 95, 109, 110, 111, 128, 129, 147, 155, 168, and 180 are preferably used.

Examples of magenta colorants include the following. Condensed azo compounds, diketopyrrolopyrrole compounds, anthraquinone compounds, quinacridone compounds, basic dye lake compounds, naphthol compounds, benzimidazolone compounds, thioindigo compounds, and perylene compounds. Among these, C.I. Pigment red 2, 3, 5, 6, 7, 23, 48:2, 48:3, 48:4, 57:1, 81:1, 122, 144, 146, 166, 169, 177, 184, 185, 202, 206, 220, 221, and 254 are preferably used.

Examples of cyan colorants include the following. Copper phthalocyanine compound and their derivatives, anthraquinone compounds, and basic dye lake compounds. Among these, C.I. Pigment blue 1, 7, 15, 15:1, 15:2, 15:3, 15:4, 60, 62, and 66 are preferably used.

The colorant is selected in consideration of the hue angle, chroma, lightness, lightfastness, OHP transparency, and dispersibility in the toner.

The content of the colorant in the toner particle with respect to 100.0 parts by mass of the binder resin is preferably from 1.0 part by mass to 20.0 parts by mass. When magnetic particles are used as a colorant, the content thereof with respect to 100.0 parts by mass of the binder resin is preferably from 40.0 parts by mass to 150.0 parts by mass.

The toner particle may comprise a charge control agent. In addition, the charge control agent may be externally added to the toner particle. When the charge control agent is used, charging characteristics can be stabilized, and an optimal triboelectric charge quantity can be controlled according to the development system.

As the charge control agent, a charge control agent which exhibits a high charging speed and can stably maintain a certain charge quantity is preferable.

Examples of charge control agents that control the toner to be negatively charged include the following: Organometallic compounds and chelate compounds are effective, and examples thereof include monoazo metallic compounds, acetylacetone metallic compounds, and aromatic oxycarboxylic acid-based, aromatic dicarboxylic acid-based, oxycarboxylic acid-based and dicarboxylic acid-based metallic compounds.

Examples of charge control agents that control the toner to be positively charged include the following: nigrosine, quaternary ammonium salts, metal salts of higher fatty acids, diorganotin borates, guanidine compounds, and imidazole compounds.

The content of the charge control agent in the toner particle with respect to 100.0 parts by mass of the toner particles is preferably 0.01 to 20.0 parts by mass, and more preferably 0.5 to 10.0 parts by mass

The toner particle may be directly used as a toner, or may be used as a toner after an external additive or the like is mixed as necessary, and adhered to the surface of the toner particle.

Examples of external additives include inorganic fine particles selected from the group consisting of silica fine particles, alumina fine particles, and titania fine particles or complex oxides thereof. Examples of complex oxides include silica aluminum fine particles and strontium titanate fine particles.

The content of the external additive with respect to 100 parts by mass of the toner particles is preferably 0.01 to 8.0 parts by mass and more preferably 0.1 to 4.0 parts by mass.

Toner particle can be produced by methods such as a suspension polymerization method, an emulsion aggregation method, a dissolution suspension method, and a pulverization method. Toner particle is preferably produced by a suspension polymerization method. The toner particle is preferably suspension-polymerized toner particle.

The suspension polymerization method will be described in detail.

For example, a polymerizable monomer composition is prepared by mixing polymerizable monomers that form an amorphous vinyl resin, a crystalline vinyl resin synthesized in advance and an aliphatic alcohol. As necessary, other materials such as a colorant, a wax, and a charge control agent may be added, and uniformly dissolved or dispersed to prepare a polymerizable monomer composition.

Then, the polymerizable monomer composition is dispersed in an aqueous medium using a stirrer or the like to prepare suspended particles of the polymerizable monomer composition. Then, the polymerizable monomers comprised in the particles are polymerized using an initiator or the like, and the obtained toner particle-dispersed solution is cooled to obtain a toner particle-dispersed solution.

After cooling, as necessary, an annealing step in which the toner particle-dispersed solution is left at a certain temperature may be performed. After the polymerization is completed, the toner particle is filtered, washed, and dried, and as necessary, an external additive can be added to obtain a toner. When a shell is formed, for example, a shell resin having a higher polarity than the crystalline vinyl resin and the amorphous vinyl resin is selected, and incorporated into the polymerizable monomer composition to form the shell.

Examples of polymerization initiators include the following:

Azo-based or diazo-based polymerization initiators such as 2,2′-azobis-(2,4-dimethylvaleronitrile), 2,2′-azobisisobutyronitrile, 1,1′-azobis(cyclohexane-1-carbonitrile), 2,2′-azobis-4-methoxy-2,4-dimethylvaleronitrile, and azobisisobutyronitrile; and peroxide-based polymerization initiators such as benzoyl peroxide, t-butyl peroxy 2-ethylhexanoate, t-butyl peroxypivalate, t-butyl peroxyisobutyrate, t-butyl peroxyoctoate, t-butyl peroxyneodecanoate, methyl ethyl ketone peroxide, diisopropyl peroxydicarbonate, cumene hydroperoxide, 2,4-dichlorobenzoyl peroxide, and lauroyl peroxide.

The polymerization initiators which are likely to cause a hydrogen abstraction reaction are peroxide-based polymerization initiators, and are preferably used. Among these, initiators such as t-butyl peroxy 2-ethylhexanoate, t-butyl peroxypivalate, t-butyl peroxyisobutyrate, t-butyl peroxyoctoate, and t-butyl peroxyneodecanoate are more preferably used.

In addition, chain transfer agents and/or polymerization inhibitors may also be used.

The aqueous medium may comprise an inorganic and/or organic dispersion stabilizer.

Examples of inorganic dispersion stabilizers include phosphates such as hydroxyapatite, tricalcium phosphate, dicalcium phosphate, magnesium phosphate, aluminum phosphate, and zinc phosphate; carbonates such as calcium carbonate and magnesium carbonate; metal hydroxides such as calcium hydroxide, magnesium hydroxide, and aluminum hydroxide; sulfates such as calcium sulfate and barium sulfate; calcium metasilicate; bentonite; silica; and alumina.

Examples of organic dispersion stabilizers include polyvinyl alcohol, gelatin, methyl cellulose, hydroxypropyl methylcellulose, ethyl cellulose, sodium salts of carboxymethylcellulose, polyacrylic acid and its salts, and starch.

When an inorganic compound is used as a dispersion stabilizer, a commercially available product may be used without change, but in order to obtain finer particles, the inorganic compound that is produced in an aqueous medium may also be used.

For example, in the case of calcium phosphate such as hydroxyapatite or tricalcium phosphate, a phosphate aqueous solution and a calcium salt aqueous solution may be mixed under high-speed stirring.

The aqueous medium may comprise a surfactant. Examples of surfactants include anionic surfactants such as sodium dodecylbenzene sulfate, and sodium oleate; cationic surfactants; amphoteric surfactants; and nonionic surfactants.

The calculation methods and measurement methods for various physical properties of toner, toner particle, and toner material will be described below. Separation of Toner Particle from Toner

By the following method, the toner particle obtained by separating the toner particle and the external additive can be used for each analysis.

A total of 160 g of sucrose (manufactured by Kishida Chemical Co., Ltd.) is added to 100 mL of ion-exchanged water and dissolved in a water bath to prepare a sucrose aqueous solution. A total of 31 g of the sucrose aqueous solution and 6 mL of Contaminone N (10% by mass aqueous solution of a neutral detergent for cleaning precision measuring instruments that is composed of a nonionic surfactant, an anionic surfactant, and an organic builder and has pH 7, manufactured by Fujifilm Wako Pure Chemical Industries, Ltd.) are placed in a centrifuge tube to prepare a dispersion liquid. To this dispersion liquid, 1 g of toner is added, and toner lumps are loosened with a spatula or the like.

A centrifuge tube was set in a “KM Shaker” (model: V.SX, commercially available from Iwaki Industry Co., Ltd.), and reciprocally shaken for 20 minutes under conditions of 350 strokes per minute. After shaking, the solution is transferred into a swing rotor glass tube (50 mL) and centrifuged in a centrifuge (H-9R, commercially available from Kokusan Co., Ltd.) under conditions of 3,500 rpm for 30 minutes.

Toner particles exist in the uppermost layer in a glass tube after centrifugation, and external additives such as fine silica particles exist in the aqueous solution side in the lower layer. The toner particle on the upper layer is collected, filtered, and washed by flushing them with 2 L of deionized water heated to 40° C., and the washed toner particle is removed.

### Differential Scanning Calorimetry (DSC) Measurement Method

The presence of the crystalline resin and amorphous resin in the toner and toner particle is measured using a differential scanning calorimeter “Q2000” (commercially available from TA Instruments) according to ASTM D3418-82. The melting points of indium and zinc are used to correct the temperature of a device detection unit, and the heat of fusion of indium is used to correct the amount of heat.

For toner measurement, first, 10 mg of the toner is accurately weighed out and put into an aluminum pan, and an empty aluminum pan is used as a reference. In a first heating process, measurement is performed while heating a measurement sample from 20° C. to 180° C. at 10° C./min, and thereby a differential scanning calorimetric curve A is obtained. Then, the sample is left at 180° C. for 10 minutes, and measurement is then performed while performing a cooling process of cooling from 180° C. to 10° C. at 10° C./min, and thereby a differential scanning calorimetric curve B is obtained. In addition, after the sample is left at 10° C. for 10 minutes, in a second heating process, measurement is performed while heating again from 10° C. to 180° C. at 10° C./min, and thereby a differential scanning calorimetric curve C is obtained. The presence of the crystalline resin is confirmed by checking the melting point peak that appears on the obtained differential scanning calorimetric curve C. In addition, when the glass transition point derived from the amorphous resin is confirmed on the differential scanning calorimetric curve C, it is determined that the toner comprises the amorphous resin.

Method of Separating Crystalline Vinyl Resin, Amorphous Vinyl Resin from Toner Particle and Other Resins Such as Shell Resin

The crystalline vinyl resin, amorphous vinyl resin and other resins such as shell resin can be separated from the toner by known methods. An example is shown below.

As a method of separating the resin component from the toner, a gradient polymer LC is used. This analysis allows separation according to the polarity of the resin in the binder resin, regardless of the molecular weight.

First, the toner is dissolved in chloroform. A sample is prepared in chloroform at a sample concentration of 0.1 mass %, and the solution is filtered through a 0.45 μm PTFE filter, which is then subjected to measurement.

The gradient polymer LC measurement conditions are as follows.
Device: UlTIMATE3000 (commercially available from Thermo Fisher Scientific)
Mobile phase: A chloroform (HPLC), B acetonitrile (HPLC)
Gradient: 2 min (A/B=0/100)→25 min (A/B=100/0)
(where the gradient of the change in the mobile phase is linear.)
Flow rate: 1.0 mL/min
Injection: 0.1 mass %×20 μL
Column: Tosoh TSKgel ODS (4.6 mmφ×150 mm×5 μm)
Column temperature: 40° C.
Detector: Corona charged aerosol detector (Corona-CAD) (commercially available from Thermo Fisher Scientific)

In a time-intensity graph obtained from the measurement, the resin component can be separated into two peaks depending on the polarity. Then, the above measurement is performed again, and the resin component can be separated into two types of resins by performing isolation when each peak reaches the valley.

The separated resins are subjected to DSC measurement, and the resin with a melting point peak is determined to be a crystalline vinyl resin, and the resin with no melting point peak is determined to be an amorphous vinyl resin. Here, when the toner comprises wax, it is necessary to separate the wax from the toner. For wax separation, a component with a molecular weight of 2,000 or less is separated as the wax using recycling HPLC.

The measurement method is as follows. First, a toner chloroform solution is prepared by the above method. Then, the obtained solution is filtered through a solvent-resistant membrane filter with a pore diameter of 0.2 μm, “Maishori Disc” (commercially available from Tosoh Corporation) to obtain a sample solution. Here, the sample solution is adjusted so that the concentration of components soluble in chloroform is 1.0 mass %. The sample solution is used for measurement under the following conditions.
Device: LC-Sakura NEXT (commercially available from Japan Analytical Industry Co., Ltd.)
Column: JAIGEL2H, 4H (commercially available from Japan Analytical Industry Co., Ltd.)
Eluent: chloroform
Flow rate: 10.0 mL/min
Oven temperature: 40.0° C.
Sample injection amount: 1.0 mL

To calculate the molecular weight of the sample there is used a molecular weight calibration curve created using a standard polystyrene resin (product name “TSK STANDARD POLYSTYRENE F-850, F-450, F-288, F-128, F-80, F-40, F-20, F-10, F-4, F-2, F-1, A-5000, A-2500, A-1000, A-500”, by Tosoh Corporation).

From the molecular weight curve thus obtained, a component with a molecular weight of 2,000 or less is repeatedly separated, and the wax is removed from the toner.

Methods of Identifying Structures of Monomer Units of Crystalline Vinyl Resin, Amorphous Vinyl Resin, and Other Resins such as Shell Resin, and Measuring Chain Length of Alkyl Group

Identification of the structures of the monomer units of the crystalline vinyl resin, the amorphous vinyl resin, and other resins such as the shell resin, and measurement of the chain length are performed by ¹H-NMR under the following conditions. The measurement sample used may be the crystalline vinyl resin and the amorphous vinyl resin separated by the above method and other resins such as the shell resin.
Measurement device: FT NMR device JNM-EX400 (commercially available from JEOL Ltd.)
Measurement frequency: 400 MHz
Pulse condition: 5.0 s
Frequency range: 10,500 Hz
Cumulative number of measurements: 64
Measurement temperature: 30° C.
Sample: 50 mg of the measurement sample is put into a sample tube with an inner diameter of 5 mm, deuterated chloroform (CDCl₃) is added as a solvent, and the sample is dissolved in a thermostatic chamber at 40° C. for preparation.

The obtained ¹H-NMR chart is analyzed, and the structure of each monomer unit is identified. The chain length of the alkyl group can be calculated from the integral ratio of proton peaks in the ¹H-NMR chart.

Here, when a polymerizable monomer that does not comprise hydrogen atoms in the components other than the vinyl group is used, the measurement nucleus is set to ¹³C using ¹³C-NMR, measurement is performed in a single pulse mode, and calculation is performed in the same manner using ¹H-NMR. In addition, the measurement results of infrared absorption spectrum (IR) and gas chromatography-mass spectrometry (GC-MS) may also be used as necessary.

### Method of Measuring Content of Crystalline Vinyl Resin and Amorphous Vinyl Resin in Binder Resin

In the method of separating the crystalline vinyl resin and the amorphous vinyl resin from the toner particle and other resins such as the shell resin, on the basis of the mass of the toner before being dissolved in chloroform and the mass of the binder resin comprising the crystalline vinyl resin and the amorphous vinyl resin separated from the toner particle and other resins such as the shell resin, the content of the crystalline vinyl resin and the amorphous vinyl resin in the binder resin is calculated.

### Method of Measuring Content of Monomer Unit (a) in Crystalline Vinyl Resin and Monomer Unit (b) in Amorphous Vinyl Resin

The content of the monomer units in the resin such as the content of the monomer unit (a) in the crystalline vinyl resin and the content of the monomer unit (b) in the amorphous vinyl resin is measured by ¹H-NMR under the following conditions.
Measurement device: FT NMR device JNM-EX400 (commercially available from JEOL Ltd.)
Measurement frequency: 400 MHz
Pulse condition: 5.0 s
Frequency range: 10,500 Hz
Cumulative number of measurements: 64
Measurement temperature: 30° C.
Sample: prepared as follows.

50 mg of the measurement sample is put into a sample tube with an inner diameter of 5 mm, deuterated chloroform (CDCl₃) is added as a solvent, and the sample is dissolved in a thermostatic chamber at 40° C. for preparation.

The obtained ¹H-NMR chart is analyzed, and the structure of each unit is identified.

In the obtained ¹H-NMR chart, among the peaks attributed to components of the monomer unit (a), a peak independent of peaks attributed to components of other units is selected, and the integral value S1 of this peak is calculated. The integral values of the other monomer units comprised in the resin are calculated in the same manner.

When the units constituting the resin component are the monomer unit (a) and one other monomer unit, the content of the monomer unit (a) is determined using the integral value S1 and the integral value S2 of the peak of the other monomer unit as follows. Here, n1 and n2 are the numbers of hydrogen atoms in the components to which the peak of interest for each site belongs.

The content of the monomer unit (a)

$$( mol \% ) = \{ ( S 1 / n 1 ) / ( ( S 1 / n 1 ) + ( S 2 / n 2 ) ) \} \times 100$$

When there are two or more types of other monomer units, the content of the monomer unit (a) can be calculated in the same manner (using S3 . . . Sx, n3 . . . nx).

When a monomer that does not comprise hydrogen atoms in the components other than the vinyl group is used, the measurement nucleus is set to ¹³C using ¹³C-NMR, measurement is performed in a single pulse mode, and calculation is performed in the same manner using ¹H-NMR. The proportion (mol %) of each monomer unit calculated by the above method is multiplied by the molecular weight of each monomer unit to convert the content of each monomer unit into mass %.

### Identification of Structure of Aliphatic Alcohol in Toner

The structure of the aliphatic alcohol in the toner can be identified by ¹H-NMR using the toner as a sample in the same method as in the above identifying the structure of the monomer units in the crystalline vinyl resin and the amorphous vinyl resin.

### Method of Measuring Content of Aliphatic Alcohol in Toner

The content of the aliphatic alcohol in the toner is measured by a calibration curve method using gas chromatography-mass spectrometry.

The sample is prepared by the following method.

1 mL of chloroform is added to 10 mg of the toner, ultrasonic waves are emitted for 1 minute, and the toner is completely dissolved. Next, methanol is added dropwise, and the resin component is re-precipitated. In this case, the dilution ratio with methanol is appropriately adjusted to a dilution ratio in a range in which the linearity can be secured in creation of a calibration curve described below, and sufficient detection accuracy is obtained in gas chromatography-mass spectrometry. Then, the sample is left for 1 hour, the supernatant liquid is filtered through a PTFE filter with an opening of 0.45 μm, and the result is used for measurement.

An aliphatic alcohol solution for the calibration curve is prepared by the following method.

10 mg of the aliphatic alcohol is weighed out and dissolved in 10 mL of methanol while heating and stirring at 100° C. The sample is diluted with methanol by a factor of 10 to 1,000 so that the aliphatic alcohol concentration is in a range of 1 ppm to 100 ppm to prepare five or more calibration curve samples.

The content of the aliphatic alcohol in the sample and the aliphatic alcohol solution for the calibration curve obtained by the above method is measured using gas chromatography-mass spectrometry under the following conditions.

Liquid introduction conditions are as follows.
Injection amount: 1 μl
Solvent: methanol
Solvent cut: 2.5 min
The conditions for gas chromatography-mass spectrometry are as follows.
Ion source temperature of 250° C.
Scan mode: m/z=46-400
SIM mode: m/z=83
Inlet temperature: 300° C.
Split setting: 50:1
Column: DB35-MS (30 m, an inner diameter of 0.25 mm, a film thickness of 0.25 μm)
Column pressure: constant flow
Emission current: 30 μA
Column heating condition: (40° C. (left for 3 min), 300° C. (10° C./min), 300° C. (left for 3 min))

The mass proportion of the aliphatic alcohol in the sample can be calculated using the calibration curve obtained by measuring the aliphatic alcohol solution for the calibration curve. On the basis of the obtained mass proportion and the amount of the binder resin in the toner in the above method of measuring the content of the crystalline vinyl resin and the amorphous vinyl resin in the binder resin, the amount of the aliphatic alcohol based on the mass of the binder resin is calculated.

### Method of Confirming Shell

The presence of the shell of the toner can be confirmed by measuring the cross-sectional morphology of the toner. A specific method of measuring the cross-sectional morphology of the toner is as follows.

First, the toner is sufficiently dispersed in the photocurable epoxy resin, and ultraviolet light is then emitted to cure the epoxy resin. The obtained cured product is cut using a microtome including a diamond blade to prepare a flaky sample with a thickness of 100 nm. After the sample is stained with ruthenium tetroxide, the cross section of the toner is observed using a transmission electron microscope (TEM) (product name: electron microscope Tecnai TF20XT, commercially available from FEI) under conditions of an acceleration voltage of 120 kV to obtain a TEM image. In this case, as the cross section of the toner, according to the method of measuring the number-average particle diameter (D1) of the toner described below, one having a major axis diameter that is 0.9 to 1.1 times the number-average particle diameter (D1) when the toner is measured is selected.

In the above observation method, the amorphous resin in the toner particle is strongly stained with ruthenium tetroxide. As a result, the shell part mainly composed of the amorphous resin is stained, and the core part comprising an unstained crystalline resin can be observed as a contrast. Here, the observation magnification is 20,000. This measurement is performed on 100 toner particles, and if a shell can be confirmed on 80 or more thereof, the toner is determined to have the shell.

### Method of Calculating Solubility Parameter (SP Value)

The SP value is determined according to the calculation method proposed by Fedors as follows.

First, the SP value of the monomer unit constituting the resin is determined as follows. Here, the monomer unit constituting the resin refers to a molecular structure when the double bonds of the monomers used when the resin is obtained by polymerization are cleaved by polymerization.

For example, when the SP value (σm) (J/cm³)^{0.5} of the monomer unit is calculated, the evaporation energy (Δei) (J/mol) and the molar volume (Δvi) (cm³/mol) for an atom or atom group in the molecular structure of the monomer unit are determined from the table described in “Polym. Eng. Sci., 14(2), 147-154 (1974)” and the SP value is calculated by the following formula.

$$σ m = {( ΣΔ ei / ΣΔ vi )}^{0.5}$$

For each monomer unit, the SP value of the resin is determined by calculating the evaporation energy (Δei) and the molar volume (Δvi) of the monomer units constituting the resin. Then, the products of the calculated values of the monomer units in the resin and the molar ratio (j) are calculated, the sum of the evaporation energies of the monomer units is divided by the sum of the molar volumes, and the SP value is calculated by the following formula.

$$σ p = {\{ ( Σ j \times ΣΔ ei ) / ( Σ j \times ΣΔ vi ) \}}^{0.5}$$

For example, if it is assumed that the resin is composed of two types of monomer units X and Y, when the composition ratios of the monomer units are Wx and Wy (mass %), the molecular weights are Mx and My, the evaporation energies are Δei (X) and Δei (Y), and the molar volumes are Δvi (X) and Δvi (Y), the molar ratios (j) of the monomer units are Wx/Mx and Wy/My, and the SP value (σp) of the resin is represented by the following formula.

$$σ p = {[ \{ ( Wx / Mx ) \times Δ ei ( X ) + Wy / My \times Δ ei ( Y ) \} / \{ ( Wx / Mx ) \times Δ vi ( X ) + Wy / My \times Δ vi ( T ) \} ]}^{0.5}$$

In addition, when two or more types of resins are mixed, the SP value (σM) of the mixture is calculated as the product of the mass composition ratio (Wi) of the mixture and the SP value (σi) of each resin, as shown in the following formula.

$$σ M = Σ ( Wi \times σ i )$$

### Method of Measuring Number-Average Particle Diameter (D1) of Toner

The volume average particle diameter (Dv) and the number-average particle diameter (D1) of the toner are calculated as follows. The measurement device used is a particle counting and analysis device “CDA-1000X” with a 100 μm aperture tube using a pore electrical resistance method (commercially available from Sysmex Corporation). The measurement conditions are set and measurement data is analyzed using bundled dedicated software “CDA-1000X (commercially available from Sysmex Corporation).”

As the electrolyte aqueous solution used for the measurement, for example, “Cellpack” (commercially available from Sysmex Corporation) can be used.

Here, before performing the measurement and analysis, dedicated software is set as follows.

On the “measurement condition setting” screen of the dedicated software, the total count number is set to 50,000, the number of repeated measurements is set to 1, and the measurement mode is set to the total count (no limit).

A specific measurement method is as follows.

(1) 150 mL of an electrolyte aqueous solution is put into a special glass round-bottom beaker, which is set on a sample stage, and stirred with a stirring propeller at 500 rpm. Then, the user clicks “blank check measurement” on the dedicated software to start the measurement, and confirms that the count number is less than 100. When the count number is 100 or more, the beaker and the aperture are washed repeatedly.

(2) 30 mL of the electrolyte aqueous solution is put into a 100 mL flat-bottomed glass beaker. 0.3 mL of a diluted solution prepared by diluting “Contaminon N” (a 10 mass % aqueous solution of a neutral detergent with pH 7 for washing precision measurement instruments, comprising a nonionic surfactant, an anionic surfactant, and an organic builder, commercially available from Wako Pure Chemical Industries, Ltd.) three mass times by weight with deionized water is added as a dispersing agent thereto.

(3) An ultrasonic disperser with an electrical output of 120 W “Ultrasonic Dispension System Tetra150” (commercially available from Nikkaki Bios Co., Ltd.), which incorporates two oscillators with an oscillation frequency of 50 kHz and with phases shifted by 180 degrees, is prepared. 3.3 L of deionized water is put into a water tank of the ultrasonic disperser, and 2 mL of Contaminon N is added to this water tank.

(4) The beaker in (2) is set in a beaker fixing hole of the ultrasonic disperser, and the ultrasonic disperser is operated. Then, the height position of the beaker is adjusted so that the resonance state of the liquid surface of the electrolyte aqueous solution in the beaker is maximized.

(5) While ultrasonic waves are emitted to the electrolyte aqueous solution in the beaker in (4), 10 mg of the toner is added little by little and dispersed. In addition, an ultrasonic dispersion treatment is additionally continued for 60 seconds. Here, during ultrasonic dispersion, the water temperature in the water tank is appropriately adjusted to be from 10° C. to 40° C.

(6) In the round-bottom beaker in (1) placed in the sample stand, the electrolyte aqueous solution in (5) in which the toner is dispersed using a pipette is added dropwise, and the measurement concentration is adjusted to 6%. Then, the measurement is performed until the number of particles measured reaches 50,000.

(7) The measurement data is analyzed using device bundled dedicated software, the volume average particle diameter (Dv) and the number-average particle diameter (D1) are calculated.

### EXAMPLES

The present disclosure is more specifically described below using examples, but the present disclosure is not limited to or by the following examples. In the following text of the examples, “parts” is on a mass basis unless specifically indicated otherwise.

### Preparation of Resin A1

The following materials were put into a reaction container including a reflux cooling tube, a stirrer, a thermometer, and a nitrogen inlet tube under a nitrogen atmosphere.
100.0 parts of toluene
100.0 parts of a monomer composition

(The monomer composition is a mixture of the following monomers in the following proportions.)
(⋅ 60.0 parts of behenyl acrylate)
(⋅ 30.0 parts of styrene)
(⋅ 10.0 parts of methacrylonitrile)
2.0 parts of a polymerization initiator t-butyl peroxypivalate (PERBUTYL PV, commercially available from NOF Corporation)

The above materials were heated to 70° C. in the reaction container with stirring at 200 rpm, a polymerization reaction was performed for 12 hours to obtain a solution in which the polymer in the monomer composition was dissolved in toluene. Subsequently, the solution was cooled to 25° C., the solution was then added to 1,000.0 parts of methanol with stirring, and a methanol-insoluble component was precipitated. The obtained methanol-insoluble component was filtered off and additionally washed with methanol and then vacuum-dried at 40° C. for 24 hours to obtain a resin A1 (crystalline vinyl resin).

When the resin A1 was analyzed by NMR, and mol % was converted to mass %, it comprised 60.0 mass % of monomer units polymerized from behenyl acrylate, 30.0 mass % of monomer units polymerized from styrene, and 10.0 mass % of monomer units polymerized from methacrylonitrile.

### Preparation of Resins A2 to A10

Crystalline resins A2 to A10 (crystalline vinyl resins) were prepared in the same manner as in the preparation of the resin A1 except that the type and addition amount of monomers used were changed as shown in Table 1. When the resins A2 to A10 were analyzed by NMR, the monomer units formed by polymerizing respective monomers were comprised in the same proportion as the monomers used.

### Preparation of Resin A11

A crystalline resin A11 (crystalline vinyl resin) was prepared in the same manner as in the preparation of the resin A1 except that the types and addition amounts of monomers and initiators used were changed as follows. When A11 was analyzed by NMR, the monomer units formed by polymerizing respective monomers were comprised in the same proportion as the monomers used.
80.0 parts of behenyl acrylate
18.0 parts of styrene
2.0 parts of methacrylic acid
0.5 parts of polymerization initiator t-butyl peroxypivalate (PERBUTYL PV, commercially available from NOF Corporation)

### Preparation of Resin B1

The following materials were put into an autoclave including a pressure reducing device, a water separating device, a nitrogen gas inlet device, a temperature measurement device, and a stirring device.
25.3 parts of terephthalic acid
74.7 parts of bisphenol A-propylene oxide 2 mol adduct
0.02 parts of potassium titanium oxalate (catalyst)

Subsequently, the reaction was caused under a nitrogen atmosphere and under atmospheric pressure at 220° C. for 5 hours, and under a reduced pressure of 220° C. for 3 hours. After cooling, the mixture was pulverized to obtain a resin B1 (amorphous polyester).

### Preparation of Resin B2

The following materials were put into a reaction container including a reflux cooling tube, a stirrer, a thermometer, and a nitrogen inlet tube under a nitrogen atmosphere.
Solvent 100.0 parts of toluene
60.0 parts of styrene
35.0 parts of acrylonitrile
2.0 parts of methacrylic acid
3.0 parts of 2-hydroxyethyl methacrylate
5.0 parts of polymerization initiator t-butyl peroxypivalate (PERBUTYL PV, commercially available from NOF Corporation)

The inside of the reaction container was heated to 70° C. with stirring at 200 rpm, and a polymerization reaction was performed for 12 hours to obtain a solution in which the polymer in the monomer composition was dissolved in toluene. Subsequently, the solution was cooled to 25° C., and the solution was then added to 1,000.0 parts of methanol with stirring to precipitate a methanol-insoluble component. The obtained methanol-insoluble component was filtered off and additionally washed with methanol and then vacuum-dried at 40° C. for 24 hours to obtain a resin B2 (amorphous vinyl).

### Preparation of Resin B3

A resin B3 (amorphous vinyl) was obtained in the same production method except that the raw material composition of the resin B2 was changed as follows.
54.0 parts of styrene
41.0 parts of acrylonitrile
2.0 parts of methacrylic acid
3.0 parts of 2-hydroxyethyl methacrylate
5.0 parts of polymerization initiator t-butyl peroxypivalate (PERBUTYL PV, commercially available from NOF Corporation)

### Preparation of Resin B4

The following materials were added to an autoclave including a pressure reducing device, a water separating device, a nitrogen gas inlet device, a temperature measurement device, and a stirring device.
64.2 parts of sebacic acid
35.8 parts of 1,6-hexanediol
0.06 parts of potassium titanium oxalate (catalyst)

Subsequently, the reaction was caused under a nitrogen atmosphere and under atmospheric pressure at 220° C. After cooling, the mixture was pulverized to obtain a resin B4. (crystalline polyester (PES))

TABLE 1

| | Monomer | | | Other monomer 1 | | Other monomer 2 | |
|---|---|---|---|---|---|---|---|
| | | Number of | Addition | | Addition | | Addition |
| | | carbon | amount | | amount | | amount |
| Resin A | Type | atoms m1 | (parts) | Type | (parts) | Type | (parts) |
| Resin A1 | Behenyl acrylate | 21 | 60.0 | Styrene | 30.0 | Methacrylonitrile | 10.0 |
| Resin A2 | Stearyl acrylate | 17 | 60.0 | Styrene | 30.0 | Methacrylonitrile | 10.0 |
| Resin A3 | Myricyl acrylate | 29 | 60.0 | Styrene | 30.0 | Methacrylonitrile | 10.0 |
| Resin A4 | Behenyl acrylate | 21 | 5.0 | Styrene | 92.0 | Methacrylonitrile | 3.0 |
| Resin A5 | Behenyl acrylate | 21 | 3.0 | Styrene | 95.0 | Methacrylonitrile | 2.0 |
| Resin A6 | Behenyl acrylate | 21 | 100.0 | — | — | — | — |
| Resin A7 | Stearyl acrylate | 17 | 60.0 | Styrene | 32.0 | Methacrylonitrile | 8.0 |
| Resin A8 | Myristyl acrylate | 13 | 60.0 | Styrene | 30.0 | Methacrylonitrile | 10.0 |
| Resin A9 | n-triacontyl acrylate | 31 | 60.0 | Styrene | 30.0 | Methacrylonitrile | 10.0 |
| Resin A10 | Behenyl acrylate | 21 | 68.0 | Styrene | 11.0 | Acrylonitrile | 11.0 |
| | n-butyl acrylate | 4 | 10.0 | | | | |
| Resin A11 | Behenyl acrylate | 21 | 80.0 | Styrene | 18.0 | Methacrylic acid | 2.0 |

The resins A1 to A11 exhibited clear endothermic peaks in differential scanning calorimeter (DSC) measurement.

### Example 1

### Production of Toner by Suspension Polymerization Method

### Production of Toner Particle 1

A mixture including the following materials was prepared.
45.0 parts of styrene
15.0 parts of n-butyl acrylate
6.4 parts of pigment blue 15:3 (colorant)

The mixture was put into an attritor (commercially available from Nippon Coke & Engineering. Co., Ltd.), and dispersion was performed using zirconia beads with a diameter of 5 mm at 200 rpm for 2 hours to obtain a raw material-dispersed solution.

On the other hand, 735.0 parts of deionized water and 16.0 parts of trisodium phosphate (12-hydrate) were put into a container including a high-speed stirring device Homomixer (commercially available from Primix Corporation) and a thermometer, and heated to 60° C. with stirring at 12,000 rpm. A calcium chloride aqueous solution in which 9.0 parts of calcium chloride (dihydrate) was dissolved in 65.0 parts of deionized water was added thereto, and while maintaining the temperature at 60° C., the mixture was stirred at 12,000 rpm for 30 minutes. 10% hydrochloric acid was added thereto to adjust the pH to 6.0, and thereby an aqueous medium in which an inorganic dispersion stabilizer comprising hydroxyapatite was dispersed in water was obtained.

Subsequently, the raw material-dispersed solution was transferred to a container including a stirring device and a thermometer, and heated to 60° C. with stirring at 100 rpm.
40.0 parts of the resin A1
4.0 parts of the resin B1
9.0 parts of DP18 (dipentaerythritol stearate wax, a melting point of 79° C., commercially available from The Nisshin OilliO Group, Ltd.)
0.1 parts of HDDA (hexanediol diacrylate)
0.52 parts of behenyl alcohol

The above materials were added thereto and stirred at 100 rpm for 30 minutes while maintaining the temperature at 60° C., 8.0 parts of t-butyl peroxypivalate (PERBUTYL PV, commercially available from NOF Corporation) as a polymerization initiator was then added, and the mixture was stirred for another 1 minute and then added to an aqueous medium that was stirred at 12,000 rpm by the high-speed stirring device. While maintaining the temperature at 60° C., stirring was continued at 12,000 rpm for 20 minutes by the high-speed stirring device to obtain a granulation liquid.

The granulation liquid was transferred to a reaction container including a reflux cooling tube, a stirrer, a thermometer, and a nitrogen inlet tube and heated to 76° C. under a nitrogen atmosphere with stirring at 150 rpm. While maintaining the temperature at 76° C., a polymerization reaction was performed at 150 rpm for 6 hours to obtain a toner particle-dispersed solution.

The obtained toner particle-dispersed solution was cooled to 48° C. with stirring at 150 rpm, and an annealing treatment was then performed for 8 hours while maintaining the temperature at 48° C. Then, while maintaining stirring, dilute hydrochloric acid was added until the pH reached 1.5 to dissolve the dispersion stabilizer. The solid content was filtered off, sufficiently washed with deionized water and then vacuum-dried at 30° C. for 24 hours to obtain toner particle 1.

When the toner particle 1 were analyzed, the toner particle 1 comprised 4,920 ppm of behenyl alcohol based on the mass of the binder resin. In addition, the toner particle 1 comprised a crystalline vinyl resin and an amorphous vinyl resin. The toner particle 1 comprised the crystalline vinyl resin and the amorphous vinyl resin in the mass proportions according to the addition parts. The monomer units constituting the amorphous vinyl resin were comprised in the same ratio as the addition ratio (mass ratio) of the monomers from which the monomer units were derived.

### Preparation of Toner 1

2.0 parts of silica fine particles (hydrophobized with hexamethyldisilazane, the number-average particle diameter of primary particles: 10 nm, BET specific surface area: 170 m²/g) as an external additive were added to 98.0 parts of the toner particle 1, and the mixture was mixed in a Henschel mixer (commercially available from Nippon Coke & Engineering. Co., Ltd.) at 3,000 rpm for 15 minutes to obtain a toner 1. The evaluation results of the obtained toner 1 are shown in Table 3.

### Examples 2 to 35

Toner particles 2 to 35 were obtained in the same manner as in Example 1 except that the type and addition amount of resins used, the type and addition amount of polymerizable monomers used, and the type and addition amount of aliphatic alcohols used were changed as shown in Table 2-1, 2-2 and 2-3.

In addition, external addition was performed in the same manner as in Example 1 to obtain toners 2 to 35. The toner evaluation results are shown in Table 3.

### Example 36

### Production of Toner by Pulverization Method

### Preparation of Amorphous Vinyl Resin 1

The following materials were put into a reaction container including a reflux cooling tube, a stirrer, a thermometer, and a nitrogen inlet tube under a nitrogen atmosphere.
100.0 parts of a solvent (toluene)
45.0 parts of styrene
15.0 parts of n-butyl acrylate
0.1 parts of HDDA (hexanediol diacrylate)
8.0 parts of a polymerization initiator t-butyl peroxypivalate (PERBUTYL PV, commercially available from NOF Corporation)

The above materials were heated to 70° C. in the reaction container with stirring at 200 rpm, a polymerization reaction was performed for 12 hours to obtain a solution in which the polymer in the monomer composition was dissolved in toluene. Subsequently, the solution was cooled to 25° C., the solution was then added to 1,000.0 parts of methanol with stirring, and a methanol-insoluble component was precipitated. The obtained methanol-insoluble component was filtered off and additionally washed with methanol and then vacuum-dried at 40° C. for 24 hours to obtain an amorphous vinyl resin 1.

When the amorphous vinyl resin 1 was analyzed by NMR, and mol % was converted to mass %, it comprised 45.0 mass % of monomer units polymerized from styrene and 15.0 mass % of monomer units polymerized from n-butyl acrylate.

### Production of Toner Particle 36

Amorphous vinyl resin 1: 60.0 parts
Resin A1: 40.0 parts
DP18 (dipentaerythritol stearate wax, a melting point of 79° C., commercially available from The Nisshin OilliO Group, Ltd.) 9.0 parts
Pigment blue 15:3 (colorant): 6.4 parts
0.50 parts of behenyl alcohol

The above materials were mixed in a Henschel mixer (model FM-75, commercially available from Mitsui Mining Co., Ltd.) at a rotational speed of 1,500 rpm for a rotation time of 5 min, and then kneaded in a twin-screw kneader (model PCM-30, commercially available from Ikegai) set to a temperature of 130° C. The obtained kneaded product was cooled and coarsely pulverized to 1 mm or less using a hammer mill to obtain a crushed product.

The obtained crushed product was finely pulverized using a mechanical pulverizer (T-250, commercially available from Turbo Industry Co., Ltd.). In addition, classification was performed using Faculty (F-300, commercially available from Hosokawa Micron Corporation) to obtain toner particle 36. The operation conditions were a classifying rotor rotational speed of 11,000 rpm and a dispersing rotor rotational speed of 7,200 rpm.

### Production of Toner 36

External addition was performed on the toner particle 36 in the same manner as in Example 1 to obtain a toner 36. The toner evaluation results are shown in Table 3.

### Comparative Examples 1 to 9, and 11

Comparative toner particles 1 to 9, 11 were obtained in the same manner as in Example 1 except that the type and addition amount of resins used, the type and addition amount of polymerizable monomers used, and the type and addition amount of aliphatic alcohols used were changed as shown in Table 2-1, 2-2 and 2-3.

In addition, external addition was performed in the same manner as in Example 1 to obtain comparative toners 1 to 9, and 11. The toner evaluation results are shown in Table 3.

### Comparative Example 10

### Production of Toner by Suspension Polymerization Method

### Preparation of Comparative Toner Particle 10

The following materials were put into an attritor (commercially available from Nippon Coke & Engineering. Co., Ltd.).
30.0 parts of methacrylonitrile
13.0 parts of styrene
7.0 parts of ethyl methacrylate
6.4 parts of Colorant pigment blue 15:3

Dispersion was performed using zirconia beads with a diameter of 5 mm at 200 rpm for 2 hours to obtain a raw material-dispersed solution.

On the other hand, 735.0 parts of deionized water and 16.0 parts of trisodium phosphate/dodecahydrate were put into a container including a high-speed stirring device Homomixer (commercially available from Primix Corporation) and a thermometer, and heated to 60° C. with stirring at 12,000 rpm. Subsequently, a calcium chloride aqueous solution in which 9.0 parts of calcium chloride/dihydrate was dissolved in 65.0 parts of deionized water was put into the container, and while maintaining the temperature at 60° C., the mixture was stirred at 12,000 rpm for 30 minutes to obtain an aqueous medium in which a dispersion stabilizer comprising hydroxyapatite was dispersed in water.

Subsequently, the raw material-dispersed solution was transferred to a container including a stirring device and a thermometer, and heated to 60° C. with stirring at 100 rpm.
50.0 parts of behenyl acrylate
10.0 parts of DP18 (dipentaerythritol stearate wax, a melting point of 79° C., commercially available from The Nisshin OilliO Group, Ltd.)
0.50 parts of behenyl alcohol

The above materials were added thereto, and while maintaining the temperature at 60° C., the mixture was stirred at 100 rpm for 30 minutes, 8.0 parts of t-butyl peroxypivalate (PERBUTYL PV, commercially available from NOF Corporation) as a polymerization initiator was then added, and the mixture was stirred for another minute and then added to an aqueous medium that was stirred at 12,000 rpm by the high-speed stirring device. While maintaining the temperature at 60° C., stirring was continued at 12,000 rpm for 20 minutes by the high-speed stirring device to obtain a granulation liquid.

The granulation liquid was transferred to a reaction container including a reflux cooling tube, a stirrer, a thermometer, and a nitrogen inlet tube and heated to 76° C. under a nitrogen atmosphere with stirring at 150 rpm. While maintaining the temperature at 76° C., a polymerization reaction was performed at 150 rpm for 6 hours to obtain a toner particle-dispersed solution.

The obtained toner particle-dispersed solution was cooled to 48° C. with stirring at 150 rpm and an annealing treatment was then performed for 8 hours while maintaining the temperature at 48° C. Then, while maintaining stirring, dilute hydrochloric acid was added until the pH reached 1.5 to dissolve the dispersion stabilizer. The solid content was filtered off, sufficiently washed with deionized water and then vacuum-dried at 30° C. for 24 hours to obtain comparative toner particle 10.

In addition, external addition was performed on the comparative toner particle 10 in the same manner as in Example 1 to obtain a comparative toner 10. The toner evaluation results are shown in Table 3.

### Comparative Example 12

### Production of Comparative Toner 12

Comparative toner particle 12 were obtained in the same manner as in Example 36 except that the resins used, that is, the resin A1 and the amorphous vinyl resin 1, were changed to the resin A10.

In addition, external addition was performed in the same manner as in Example 1 to obtain a comparative toner 12. The toner evaluation results are shown in Table 3.

### Comparative Example 13

### Preparation of Comparative Crystalline Polyester Resin 1

1,6-hexanediol: 34.5 parts
(0.29 mol; 100.0 mol % based on a total number of moles of polyhydric alcohols)
Dodecanedioic acid: 65.5 parts
(0.28 mol; 100.0 mol % based on a total number of moles of polyvalent carboxylic acids)
Tin 2-ethylhexanoate: 0.5 parts

The above materials were weighed out in a reaction chamber including a cooling tube, a stirrer, a nitrogen inlet tube, and a thermocouple. The inside of the flask was replaced with nitrogen gas, the temperature was then gradually raised with stirring, and the reaction was caused for 3 hours while stirring at a temperature of 140° C.

Next, the pressure in the reaction chamber was lowered to 8.3 kPa, and the reaction was caused for 4 hours while maintaining the temperature at 200° C. Then, the pressure of the reaction chamber was reduced to 5 kPa or less, the reaction was caused at 200° C. for 3 hours, and thereby a comparative crystalline polyester resin 1 was obtained.

### Production of Comparative Toner 13

Comparative toner particle 13 were obtained in the same manner as in Example 1 except that the comparative crystalline polyester resin 1 was added in place of the resin A1.

In addition, external addition was performed in the same manner as in Example 1 to obtain comparative toner particle 13. The toner evaluation results are shown in Table 3.

### Comparative Example 14

### Preparation of Comparative Amorphous Polyester Resin 1

Bisphenol A/propylene oxide adduct (an average number of moles added of 2.0): 37.0 parts (13.6 mol %)
Ethylene glycol: 13.0 parts (35.5 mol %)
Terephthalic acid: 50.0 parts (50.9 mol %)
Titanium tetrabutoxide (esterification catalyst): 0.5 parts

The above materials were weighed out in a reaction chamber including a cooling tube, a stirrer, a nitrogen inlet tube, and a thermocouple. Next, the inside of the flask was replaced with nitrogen gas, the temperature was then gradually raised with stirring, and the reaction was caused for 2 hours while stirring at a temperature of 200° C.

In addition, the pressure in the reaction chamber was lowered to 8.3 kPa, the reaction was caused for 5 hours while maintaining the temperature at 200° C., and after it was confirmed that the softening point measured according to ASTM D36-86 reached a temperature of 100° C., the temperature was lowered to stop the reaction, and thereby a comparative amorphous polyester resin 1 was obtained.

### Production of Comparative Toner 14

Comparative toner particle 14 were obtained in the same manner as in Example 36 except that the comparative amorphous polyester resin 1 was added in place of the amorphous vinyl resin 1.

In addition, external addition was performed in the same manner as in Example 1 to obtain a comparative toner 14. The toner evaluation results are shown in Table 3.

### Comparative Example 15

### Production of Comparative Toner Particle 15

15.0 parts of n-dodecyl acrylate
45.0 parts of styrene
6.5 parts of colorant (pigment blue 15:3)

A mixture including the above materials was prepared. The mixture was put into an attritor (commercially available from Nippon Coke & Engineering. Co., Ltd.), and dispersion was performed using zirconia beads with a diameter of 5 mm at 200 rpm for 2 hours to obtain a raw material-dispersed solution.

On the other hand, 735.0 parts of deionized water and 16.0 parts of trisodium phosphate (12-hydrate) were put into a container including a high-speed stirring device Homomixer (commercially available from Primix Corporation) and a thermometer, and heated to 60° C. with stirring at 12,000 rpm. A calcium chloride aqueous solution in which 9.0 parts of calcium chloride (dihydrate) was dissolved in 65.0 parts of deionized water was added thereto, and while maintaining the temperature at 60° C., the mixture was stirred at 12,000 rpm for 30 minutes. 10% hydrochloric acid was added thereto to adjust the pH to 6.0, and thereby an aqueous medium in which an inorganic dispersion stabilizer comprising hydroxyapatite was dispersed in water was obtained.

Subsequently, the raw material-dispersed solution was transferred to a container including a stirring device and a thermometer, and heated to 60° C. with stirring at 100 rpm.
Crystalline resin A11: 40.0 parts
Mold release agent 1: 9.0 parts
(mold release agent 1: DP18 (dipentaerythritol stearate wax) a melting point of 79° C., commercially available from Nippon Seiro Co., Ltd.)

The above materials were added thereto and stirred at 100 rpm for 30 minutes while maintaining the temperature at 60° C., 9.0 parts of t-butyl peroxypivalate (PERBUTYL PV, commercially available from NOF Corporation) as a polymerization initiator was then added, and the mixture was stirred for another minute, and then added to an aqueous medium that was stirred at 12,000 rpm by the high-speed stirring device. While maintaining the temperature at 60° C., stirring was continued at 12,000 rpm for 20 minutes by the high-speed stirring device to obtain a granulation liquid.

The granulation liquid was transferred to a reaction container including a reflux cooling tube, a stirrer, a thermometer, and a nitrogen inlet tube and heated to 70° C. under a nitrogen atmosphere with stirring at 150 rpm. While maintaining the temperature at 70° C., a polymerization reaction was performed at 150 rpm for 12 hours to obtain a toner particle-dispersed solution.

The obtained toner particle-dispersed solution was cooled to 45° C. with stirring at 150 rpm and then heated for 5 hours while maintaining at 45° C. Then, while maintaining stirring, dilute hydrochloric acid was added until the pH reached 1.5 to dissolve the dispersion stabilizer. The solid content was filtered off, sufficiently washed with deionized water, and then vacuum-dried at 30° C. for 24 hours to obtain comparative toner particle 15.

### Preparation of Comparative Toner 15

External addition was performed in the same manner as in Example 1 to obtain a comparative toner 15.

The toner evaluation results are shown in Table 3.

TABLE 2-1

| | | | Binder resin | | | | | | | |
|---|---|---|---|---|---|---|---|---|---|---|
| | | | | | | | CV | | | |
| Example | Toner | Production | Resin A | | | | proportion | Resin B | | |
| No. | No. | method | No. | m1 | SPA | Parts | mass % | No. | Parts | SPS |
| 1 | 1 | SP | A1 | 21 | 19.5 | 40.0 | 38.5 | B1 | 4.0 | 20.3 |
| 2 | 2 | SP | A2 | 17 | 19.6 | 40.0 | 38.5 | B1 | 4.0 | 20.3 |
| 3 | 3 | SP | A3 | 29 | 19.4 | 40.0 | 38.5 | B1 | 4.0 | 20.3 |
| 4 | 4 | SP | A1 | 21 | 19.5 | 40.0 | 38.5 | B1 | 4.0 | 20.3 |
| 5 | 5 | SP | A1 | 21 | 19.5 | 40.0 | 38.5 | B1 | 4.0 | 20.3 |
| 6 | 6 | SP | A1 | 21 | 19.5 | 40.0 | 38.5 | B1 | 4.0 | 20.3 |
| 7 | 7 | SP | A1 | 21 | 19.5 | 40.0 | 38.5 | B1 | 4.0 | 20.3 |
| 8 | 8 | SP | A1 | 21 | 19.5 | 40.0 | 38.5 | B1 | 4.0 | 20.3 |
| 9 | 9 | SP | A1 | 21 | 19.5 | 40.0 | 38.5 | B1 | 4.0 | 20.3 |
| 10 | 10 | SP | A1 | 21 | 19.5 | 40.0 | 38.5 | B1 | 4.0 | 20.3 |
| 11 | 11 | SP | A1 | 21 | 19.5 | 40.0 | 38.5 | B1 | 4.0 | 20.3 |
| 12 | 12 | SP | A1 | 21 | 19.5 | 40.0 | 38.5 | B1 | 4.0 | 20.3 |
| 13 | 13 | SP | A1 | 21 | 19.5 | 58.4 | 56.2 | B1 | 4.0 | 20.3 |
| 14 | 14 | SP | A1 | 21 | 19.5 | 74.0 | 71.2 | B1 | 4.0 | 20.3 |
| 15 | 15 | SP | A1 | 21 | 19.5 | 78.2 | 75.2 | B1 | 4.0 | 20.3 |
| 16 | 16 | SP | A1 | 21 | 19.5 | 6.4 | 6.2 | B1 | 4.0 | 20.3 |
| 17 | 17 | SP | A1 | 21 | 19.5 | 3.8 | 3.7 | B1 | 4.0 | 20.3 |
| 18 | 18 | SP | A1 | 21 | 19.5 | 1.0 | 1.0 | B1 | 4.0 | 20.3 |
| 19 | 19 | SP | A1 | 21 | 19.5 | 40.0 | 38.5 | B1 | 4.0 | 20.3 |
| 20 | 20 | SP | A1 | 21 | 19.5 | 40.0 | 38.5 | B1 | 4.0 | 20.3 |
| 21 | 21 | SP | A1 | 21 | 19.5 | 40.0 | 38.5 | B1 | 4.0 | 20.3 |
| 22 | 22 | SP | A1 | 21 | 19.5 | 40.0 | 38.5 | B1 | 4.0 | 20.3 |
| 23 | 23 | SP | A4 | 21 | 20.2 | 40.0 | 38.5 | B1 | 4.0 | 20.3 |
| 24 | 24 | SP | A5 | 21 | 20.2 | 40.0 | 38.5 | B1 | 4.0 | 20.3 |
| 25 | 25 | SP | A6 | 21 | 18.4 | 40.0 | 38.5 | B1 | 4.0 | 20.3 |
| 26 | 26 | SP | A1 | 21 | 19.5 | 40.0 | 38.5 | B1 | 4.0 | 20.3 |
| 27 | 27 | SP | A1 | 21 | 19.5 | 40.0 | 38.5 | B1 | 4.0 | 20.3 |
| 28 | 28 | SP | A1 | 21 | 19.5 | 40.0 | 38.5 | B1 | 4.0 | 20.3 |
| 29 | 29 | SP | A1 | 21 | 19.5 | 40.0 | 38.5 | B1 | 4.0 | 20.3 |
| 30 | 30 | SP | A1 | 21 | 19.5 | 40.0 | 38.5 | B1 | 4.0 | 20.3 |
| 31 | 31 | SP | A1 | 21 | 19.5 | 40.0 | 40.0 | — | — | — |
| 32 | 32 | SP | A6 | 21 | 18.4 | 40.0 | 38.5 | B2 | 4.0 | 23.4 |
| 33 | 33 | SP | A6 | 21 | 18.4 | 40.0 | 38.5 | B3 | 4.0 | 23.9 |
| 34 | 34 | SP | A1 | 21 | 19.5 | 40.0 | 38.5 | B4 | 4.0 | — |
| 35 | 35 | SP | A1 | 19 | 19.5 | 20.0 | 38.5 | B1 | 4.0 | 20.3 |
| | | | A7 | | | 20.0 | | | | |
| 36 | 36 | P | A1 | 21 | 19.5 | 40.0 | 40.0 | — | — | — |
| Comparative 1 | Comparative 1 | SP | A1 | 21 | 19.5 | 40.0 | 38.5 | B1 | 4.0 | 20.3 |
| Comparative 2 | Comparative 2 | SP | A1 | 21 | 19.5 | 40.0 | 38.5 | B1 | 4.0 | 20.3 |
| Comparative 3 | Comparative 3 | SP | A1 | 21 | 19.5 | 40.0 | 38.5 | B1 | 4.0 | 20.3 |
| Comparative 4 | Comparative 4 | SP | A1 | 21 | 19.5 | 40.0 | 38.5 | B1 | 4.0 | 20.3 |
| Comparative 5 | Comparative 5 | SP | A1 | 21 | 19.5 | 40.0 | 38.5 | B1 | 4.0 | 20.3 |
| Comparative 6 | Comparative 6 | SP | A8 | 13 | 19.2 | 40.0 | 38.5 | B1 | 4.0 | 20.3 |
| Comparative 7 | Comparative 7 | SP | A9 | 31 | 19.1 | 40.0 | 38.5 | B1 | 4.0 | 20.3 |
| Comparative 8 | Comparative 8 | SP | A1 | 21 | 19.5 | 40.0 | 38.5 | B1 | 4.0 | 20.3 |
| Comparative 9 | Comparative 9 | SP | A1 | 21 | 19.5 | 40.0 | 38.5 | B1 | 4.0 | 20.3 |
| Comparative 10 | Comparative 10 | SP | — | — | — | — | 100.0 | — | — | — |
| Comparative 11 | Comparative 11 | SP | — | — | — | — | — | B1 | 4.0 | 20.3 |
| Comparative 12 | Comparative 12 | P | A10 | 21 | 19.7 | 100.0 | 100.0 | — | — | — |
| Comparative 13 | Comparative 13 | SP | — | — | — | — | — | B1 | 4.0 | 20.3 |
| Comparative 14 | Comparative 14 | P | A1 | 21 | 19.5 | 40.0 | 40.0 | — | — | — |
| Comparative 15 | Comparative 15 | SP | A11 | 21 | 18.7 | 40.0 | 40.0 | — | — | — |

TABLE 2-2

| | | Binder resin | | | | |
|---|---|---|---|---|---|---|
| | | Polymerizable | | | | |
| | | monomer 1 | | | | AV |
| Example | Toner | Styrene | Polymerizable monomer 2 | | | proportion |
| No. | No. | Parts | Type | m2 | Parts | mass % |
| 1 | 1 | 45.0 | n-butyl acrylate | 3 | 15.0 | 57.7 |
| 2 | 2 | 45.0 | n-butyl acrylate | 3 | 15.0 | 57.7 |
| 3 | 3 | 45.0 | n-butyl acrylate | 3 | 15.0 | 57.7 |
| 4 | 4 | 45.0 | methyl acrylate | 1 | 15.0 | 57.7 |
| 5 | 5 | 45.0 | n-dodecyl acrylate | 11 | 15.0 | 57.7 |
| 6 | 6 | 45.0 | n-butyl acrylate | 3 | 15.0 | 57.7 |
| 7 | 7 | 45.0 | n-butyl acrylate | 3 | 15.0 | 57.7 |
| 8 | 8 | 45.0 | n-butyl acrylate | 3 | 15.0 | 57.7 |
| 9 | 9 | 45.0 | n-butyl acrylate | 3 | 15.0 | 57.7 |
| 10 | 10 | 45.0 | n-butyl acrylate | 3 | 15.0 | 57.7 |
| 11 | 11 | 45.0 | n-butyl acrylate | 3 | 15.0 | 57.7 |
| 12 | 12 | 45.0 | n-butyl acrylate | 3 | 15.0 | 57.7 |
| 13 | 13 | 31.2 | n-butyl acrylate | 3 | 10.4 | 40.0 |
| 14 | 14 | 19.5 | n-butyl acrylate | 3 | 6.5 | 25.0 |
| 15 | 15 | 16.4 | n-butyl acrylate | 3 | 5.5 | 21.0 |
| 16 | 16 | 70.2 | n-butyl acrylate | 3 | 23.4 | 90.0 |
| 17 | 17 | 72.2 | n-butyl acrylate | 3 | 24.1 | 92.5 |
| 18 | 18 | 74.3 | n-butyl acrylate | 3 | 24.8 | 95.2 |
| 19 | 19 | 45.0 | n-butyl acrylate | 3 | 15.0 | 57.7 |
| 20 | 20 | 45.0 | n-butyl acrylate | 3 | 15.0 | 57.7 |
| 21 | 21 | 45.0 | n-dodecyl acrylate | 11 | 15.0 | 57.7 |
| 22 | 22 | 45.0 | n-dodecyl acrylate | 11 | 15.0 | 57.7 |
| 23 | 23 | 45.0 | n-butyl acrylate | 3 | 15.0 | 57.7 |
| 24 | 24 | 45.0 | n-butyl acrylate | 3 | 15.0 | 57.7 |
| 25 | 25 | 45.0 | n-butyl acrylate | 3 | 15.0 | 57.7 |
| 26 | 26 | 45.0 | n-propyl acrylate | 2 | 15.0 | 57.7 |
| 27 | 27 | 12.0 | n-butyl acrylate | 3 | 48.0 | 57.7 |
| 28 | 28 | 10.8 | n-butyl acrylate | 3 | 49.2 | 57.7 |
| 29 | 29 | 48.0 | n-butyl acrylate | 3 | 12.0 | 57.7 |
| 30 | 30 | 49.2 | n-butyl acrylate | 3 | 10.8 | 57.7 |
| 31 | 31 | 45.0 | n-butyl acrylate | 3 | 15.0 | 60.0 |
| 32 | 32 | 45.0 | n-butyl acrylate | 3 | 15.0 | 57.7 |
| 33 | 33 | 45.0 | n-butyl acrylate | 3 | 15.0 | 57.7 |
| 34 | 34 | 45.0 | n-butyl acrylate | 3 | 15.0 | 57.7 |
| 35 | 35 | 45.0 | n-butyl acrylate | 3 | 15.0 | 57.7 |
| 36 | 36 | 45.0 | n-butyl acrylate | 3 | 15.0 | 60.0 |
| Comparative 1 | Comparative 1 | 45.0 | n-butyl acrylate | 3 | 15.0 | 57.7 |
| Comparative 2 | Comparative 2 | 45.0 | n-butyl acrylate | 3 | 15.0 | 57.7 |
| Comparative 3 | Comparative 3 | 45.0 | n-butyl acrylate | 3 | 15.0 | 57.7 |
| Comparative 4 | Comparative 4 | 45.0 | n-butyl acrylate | 3 | 15.0 | 57.7 |
| Comparative 5 | Comparative 5 | 45.0 | n-butyl acrylate | 15 | 15.0 | 57.7 |
| Comparative 6 | Comparative 6 | 45.0 | n-butyl acrylate | 3 | 15.0 | 57.7 |
| Comparative 7 | Comparative 7 | 45.0 | n-butyl acrylate | 3 | 15.0 | 57.7 |
| Comparative 8 | Comparative 8 | 45.0 | n-butyl acrylate | 3 | 15.0 | 57.7 |
| Comparative 9 | Comparative 9 | 45.0 | n-butyl acrylate | 3 | 15.0 | 57.7 |
| Comparative 10 | Comparative 10 | — | — | — | — | 0.0 |
| Comparative 11 | Comparative 11 | 75.0 | n-butyl acrylate | 3 | 25.0 | 96.2 |
| Comparative 12 | Comparative 12 | — | — | — | — | 0.0 |
| Comparative 13 | Comparative 13 | 45.0 | n-butyl acrylate | 3 | 15.0 | 57.7 |
| Comparative 14 | Comparative 14 | — | — | — | — | 0.0 |
| Comparative 15 | Comparative 15 | 45.0 | n-dodecyl acrylate | 11 | 15.0 | 60.0 |

In the tables, in the production method column, SP indicates the suspension polymerization method, and P indicates the pulverization method. m1 is m1 in Formula (1), and m2 is m2 in Formula (2). The CV proportion is the content of the crystalline vinyl resin based on the mass of the binder resin (mass %), and the AV proportion is the content of the amorphous vinyl resin (mass %) based on the mass of the binder resin.

TABLE 2-3

| | | Aliphatic alcohol | | | | | | |
|---|---|---|---|---|---|---|---|---|
| | | | | | Detection | | | |
| | | | | Addition | amount in | | | |
| | Toner | | Formula(3) | amount | toner | \|m1 − | \|m2 − | SPS- |
| | No. | Type | m3 | (parts) | (ppm) | m3\| | m3\| | SPA |
| Example 1 | 1 | Behenyl alcohol | 21 | 0.52 | 4920 | 0 | 18 | 0.8 |
| Example 2 | 2 | Behenyl alcohol | 21 | 0.52 | 4952 | 4 | 18 | 0.7 |
| Example 3 | 3 | Behenyl alcohol | 21 | 0.52 | 5071 | 8 | 18 | 0.9 |
| Example 4 | 4 | Behenyl alcohol | 21 | 0.52 | 5055 | 0 | 20 | 0.8 |
| Example 5 | 5 | Behenyl alcohol | 21 | 0.52 | 5012 | 0 | 10 | 0.8 |
| Example 6 | 6 | Cetanol | 15 | 0.52 | 5007 | 6 | 12 | 0.8 |
| Example 7 | 7 | Myricyl alcohol | 29 | 0.52 | 5015 | 8 | 26 | 0.8 |
| Example 8 | 8 | Behenyl alcohol | 21 | 0.01 | 103 | 0 | 18 | 0.8 |
| Example 9 | 9 | Behenyl alcohol | 21 | 0.10 | 1011 | 0 | 18 | 0.8 |
| Example 10 | 10 | Behenyl alcohol | 21 | 0.31 | 3136 | 0 | 18 | 0.8 |
| Example 11 | 11 | Behenyl alcohol | 21 | 1.04 | 9854 | 0 | 18 | 0.8 |
| Example 12 | 12 | Behenyl alcohol | 21 | 0.62 | 5998 | 0 | 18 | 0.8 |
| Example 13 | 13 | Behenyl alcohol | 21 | 0.52 | 5021 | 0 | 18 | 0.8 |
| Example 14 | 14 | Behenyl alcohol | 21 | 0.52 | 4988 | 0 | 18 | 0.8 |
| Example 15 | 15 | Behenyl alcohol | 21 | 0.52 | 4976 | 0 | 18 | 0.8 |
| Example 16 | 16 | Behenyl alcohol | 21 | 0.52 | 4928 | 0 | 18 | 0.8 |
| Example 17 | 17 | Behenyl alcohol | 21 | 0.52 | 5033 | 0 | 18 | 0.8 |
| Example 18 | 18 | Behenyl alcohol | 21 | 0.52 | 4968 | 0 | 18 | 0.8 |
| Example 19 | 19 | 1-tetracosanol | 23 | 0.52 | 5021 | 2 | 20 | 0.8 |
| Example 20 | 20 | 1-hexacosanol | 25 | 0.52 | 5079 | 4 | 22 | 0.8 |
| Example 21 | 21 | 1-octadecanol | 17 | 0.52 | 4944 | 4 | 6 | 0.8 |
| Example 22 | 22 | Cetanol | 15 | 0.52 | 4907 | 6 | 4 | 0.8 |
| Example 23 | 23 | Behenyl alcohol | 21 | 0.52 | 4909 | 0 | 18 | 0.1 |
| Example 24 | 24 | Behenyl alcohol | 21 | 0.52 | 4954 | 0 | 18 | 0.1 |
| Example 25 | 25 | Behenyl alcohol | 21 | 0.52 | 4988 | 0 | 18 | 1.9 |
| Example 26 | 26 | Behenyl alcohol | 21 | 0.52 | 5008 | 0 | 19 | 0.8 |
| Example 27 | 27 | Behenyl alcohol | 21 | 0.52 | 5039 | 0 | 18 | 0.8 |
| Example 28 | 28 | Behenyl alcohol | 21 | 0.52 | 4997 | 0 | 18 | 0.8 |
| Example 29 | 29 | Behenyl alcohol | 21 | 0.52 | 4986 | 0 | 18 | 0.8 |
| Example 30 | 30 | Behenyl alcohol | 21 | 0.52 | 4977 | 0 | 18 | 0.8 |
| Example 31 | 31 | Behenyl alcohol | 21 | 0.50 | 4963 | 0 | 18 | — |
| Example 32 | 32 | Behenyl alcohol | 21 | 0.52 | 4946 | 0 | 18 | 5 |
| Example 33 | 33 | Behenyl alcohol | 21 | 0.52 | 4961 | 0 | 18 | 5.5 |
| Example 34 | 34 | Behenyl alcohol | 21 | 0.52 | 5081 | 0 | 18 | — |
| Example 35 | 35 | Behenyl alcohol | 21 | 0.52 | 5055 | 2 | 18 | 0.8 |
| Example 36 | 36 | Behenyl alcohol | 21 | 0.50 | 5049 | 0 | 18 | — |
| C.E. 1 | C. 1 | 1-tetradecanol | 13 | 0.52 | 4982 | 8 | 10 | 0.8 |
| C.E. 2 | C. 2 | 1-dotriacontanol | 31 | 0.52 | 4988 | 10 | 28 | 0.8 |
| C.E. 3 | C. 3 | Behenyl alcohol | 21 | 0.01 | 92 | 0 | 18 | 0.8 |
| C.E. 4 | C. 4 | Behenyl alcohol | 21 | 1.05 | 10095 | 0 | 18 | 0.8 |
| C.E. 5 | C. 5 | Behenyl alcohol | 21 | 0.52 | 5021 | 0 | 6 | 0.8 |
| C.E. 6 | C. 6 | Behenyl alcohol | 21 | 0.52 | 4968 | 8 | 18 | 1.1 |
| C.E. 7 | C. 7 | Behenyl alcohol | 21 | 0.52 | 5066 | 10 | 18 | 1.2 |
| C.E. 8 | C. 8 | — | — | — | — | — | — | 0.8 |
| C.E. 9 | C. 9 | 2-hexyldecyl alcohol | 21 | 0.52 | 5064 | — | — | 0.8 |
| C.E. 10 | C. 10 | Behenyl alcohol | 21 | 0.50 | 5051 | 0 | — | — |
| C.E. 11 | C. 11 | Behenyl alcohol | 21 | 0.52 | 4955 | — | 18 | 0.8 |
| C.E. 12 | C. 12 | Behenyl alcohol | 21 | 0.50 | 4972 | 0 | — | — |
| C.E. 13 | C. 13 | Behenyl alcohol | 21 | 0.52 | 4991 | — | 18 | — |
| C.E. 14 | C. 14 | Behenyl alcohol | 21 | 0.50 | 4983 | 0 | — | — |
| C.E. 15 | C. 15 | — | — | — | — | — | — | — |

In the table, “C.E.” indicates “Comparative Example”, and the description such as “C.1” indicates “Comparative 1”.

In Table 2-3, the addition amount of the aliphatic alcohol is the number of parts by mass with respect to 100 parts by mass of the binder resin. The detection amount in the toner is the amount of the aliphatic alcohol (ppm by mass) based on the mass of the binder resin. SPS-SPA is SP_{S}-SP_{A} (J/cm³)^{0.5}.

The toners of Examples 1 to 36 and Comparative Examples 1 to 15 were subjected to the following evaluations.

The evaluation results are shown in Table 3.

Here, in each toner using the resin B, it was confirmed that the toner particle had a shell made of the resin B.

### Toner Evaluating Method

### <1> Evaluation of Low-Temperature Fixability

A process cartridge filled with a toner (a process cartridge for a laser beam printer (LBP-712Ci, commercially available from Canon Inc.)) was left at 25° C. and a humidity of 40% RH for 48 hours.

Using a modified machine that was modified on the basis of a laser beam printer (LBP-712Ci, commercially available from Canon Inc.) so that it could operate even if the fixing unit was removed, an unfixed image with an image pattern in which 10 mm×10 mm square images were evenly arranged at 9 points across the entire transfer paper was output. The amount of the toner applied to the transfer paper was 0.80 mg/cm², and the fixing onset temperature was evaluated. Here, the transfer paper used was A4 size paper (prober bond paper: 105 g/m², commercially available from Fox River).

The fixing unit used was an external fixing unit that was modified so that it could operate outside of a laser beam printer by removing the fixing unit of the laser beam printer (LBP-712Ci, commercially available from Canon Inc.) to the outside. Here, the fixation temperature of the external fixing unit was increased in 5° C. increments from 90° C., and fixing was performed under conditions of a process speed: 360 mm/s.

The fixed image was visually checked, the lowest temperature at which no cold offset occurred was set as the fixing onset temperature, and the low-temperature fixability was evaluated. A fixing onset temperature of 120° C. or lower was determined to be good. The evaluation results are shown in Table 3.

### <2> Evaluation of Hot Offset Resistance

The maximum temperature at which hot offset was not observed under the same conditions as for the low-temperature fixability was set as the maximum fixation temperature, and the difference between the maximum fixation temperature and the fixing onset temperature was set as a fixable range. A fixable range of 40° C. or higher was determined to be good.

The evaluation results are shown in Table 3.

### <3> Evaluation of Gloss Stability

As the fixing unit, the external fixing unit used in the above evaluation <1> was used. As the transfer paper, A5 size paper (PB PAPER, commercially available from Canon Inc.) was used, and at the fixing onset temperature in the above evaluation <1>, 100 sheets of fixed images were continuously output at a paper feed rate of 38 sheets/min. For the evaluation, an unfixed image with an image pattern in which 10 mm×10 mm square images were evenly arranged at 9 points across the entire transfer paper was used. In this case, the image pattern was formed so that the centers of the square images at both ends (6 points) were located at positions 7 mm from the both ends of the paper.

The gloss value of the image fixed on the 100th sheet was measured using a handy gloss meter PG-1 (commercially available from Nippon Denshoku Industries Co., Ltd.).

In the measurement conditions, the light projection angle and the light reception angle were set to 75°, all of the image patterns arranged at 9 points were measured, and the average gloss value was evaluated. In addition, the standard deviation of the measured value was used as the gloss unevenness and used to evaluate the gloss stability. A standard deviation (gloss unevenness) of less than 3.00 was determined to be good.

The evaluation results are shown in Table 3.

### <4> Evaluation of Bending Resistance

A printer LBP-712Ci (commercially available from Canon Inc.) was used to evaluate the bending resistance. A process cartridge filled with a toner was left in an environment at 25° C. and a humidity of 40% RH for 48 hours. Using the printer, two sheets of transfer paper with 50 mm×50 mm solid images with a toner laid-on level of 0.8 mg/cm² formed in the center at the fixing onset temperature measured in the above low-temperature fixability evaluation+10° C. were printed. One of the printed solid images was subjected to the following bending operation. In the bending operation, the transfer paper was bent so that the valley fold lines drew the diagonal lines of the solid image, and the transfer paper was bent so that the mountain fold lines bisected each side of the transfer image and a cross was drawn at the center of the solid image. That is, after one bending operation, on the solid image, two valley fold lines and two mountain fold lines were formed.

The bending operation was performed five times. That is, after the above bending was performed, the transfer paper was unbent and then bent again at the same position, which was repeated for a total of five bending operations. After the bending operation was completed, the transfer paper was unbent, covered with soft thin paper (product name “Dusper,” commercially available from Ozu Corporation), and rubbed back and forth eight times while applying a load of 4.9 kPa from above the thin paper. The image density was measured using the intersection of four bending lines as the center of the solid image.

One sheet of the printed solid images was not bent but only rubbed, and the image density was measured at the center of the solid image.

The image densities at the center of the solid images on the transfer paper that had been bent and the transfer paper that had not been bent were compared, and the rate ΔD (%) of decrease in image density was evaluated.

This ΔD (%) was used as an index of bending resistance. A rate of decrease in image density of 9.0% or less was determined to be good. Here, the rate of decrease in image density was calculated by the following calculation formula.

$$Δ D ( \% ) = \{ ( the image density of the transfer paper that had not been bent - the image density of the transfer paper that had been bent ) / the image density of the transfer paper that had not been bent \} \times 100$$

The image density was measured by a color reflection densitometer (X-Rite 404A, commercially available from X-Rite). The evaluation results are shown in Table 3.

### <5> Evaluation of Charge Stability

Using an LBP-712Ci, in a high temperature and high humidity environment (HH) (a temperature of 32.5° C. and a humidity of 80% RH), 3,000 sheets of images were printed out using the printer at a print percentage of 1%. After leaving it for 3 days, one sheet of images with a white background was printed out. The reflectance of the obtained image was measured using a reflection densitometer (reflectometer model TC-6DS commercially available from Tokyo Denshoku Co., Ltd.). The filter used in the measurement was an amber filter.

Dr-Ds, where Ds (%) was the worst value when the white background reflectance was measured at 5 points, and Dr (%) was the reflectance of the transfer material before image formation, was evaluated as fogging after being left in an HH. The evaluation results are shown in Table 3. A fogging of 2.2% or less was determined to be good.

### <6> Evaluation of Heat-Resistant Storability

In order to evaluate the stability during storage, the heat-resistant storability was evaluated.

5 g of the toner was placed in a 100 mL resin cup and left in an environment at a temperature of 50° C. and a humidity of 70% RH for 3 days, and the degree of agglomeration of the toner was then measured and evaluated as follows. As the measurement device, a device obtained by connecting a digital display vibration meter “DIGI-VIBRO MODEL 1332A” (commercially available from Showasokki Co., Ltd.) to a vibration table side part of a “powder tester” (commercially available from Hosokawa Micron Corporation) was used.

Then, on the vibration table of the powder tester, a sieve with an opening of 38 μm (400 mesh), a sieve with an opening of 75 μm (200 mesh), and a sieve with an opening of 150 μm (100 mesh) were stacked and set in that order from bottom to top. The measurement was performed in an environment at 23° C. and a humidity of 60% RH as follows.

(1) The vibration amplitude of the vibration table was adjusted in advance so that the displacement value of a digital display vibration meter was 0.60 mm (peak-to-peak).

(2) The toner left for 3 days as described above was left in an environment at 23° C. and a humidity of 60% RH for 24 hours in advance. Then, 5.00 g of the toner was accurately weighed out, and gently placed on the top sieve with an opening of 150 m.

(3) The sieve was vibrated for 15 seconds, the mass of the toner remaining on each sieve was then measured, and the degree of agglomeration was calculated on the basis of the following formula. The evaluation results are shown in Table 3.

$$The degree of agglomeration ( \% ) = \{ ( the mass ( g ) of the sample on the sieve with an opening of 150 μm ) / 5. ( g ) \} \times 100 + \{ ( the mass ( g ) of the sample on the sieve with an opening of 75 μm ) / 5. ( g ) \} \times 100 \times 0.6 + \{ ( the mass ( g ) of the sample on the sieve with an opening of 38 μ m ) / 5. ( g ) \} \times 100 \times 0.2$$

TABLE 3

| | | | | | | Bending | Charge | |
|---|---|---|---|---|---|---|---|---|
| | | Low. | | | | resistance | stability | |
| | | temperature | | | | Rate of | Fogging | Heat-resistant |
| | | fixability | Hot offset | Gloss stability | | decrease in | after | storability |
| | | Fixing onset | resistance | Average | | image | leaving | Degree of |
| | | temperature | Difference | gloss | Gloss | density | in HH | agglomeration |
| | Toner | (° C.) | (° C.) | value | unevenness | (%) | (%) | (%) |
| Example 1 | Toner 1 | 100 | +65 | 26.5 | 0.64 | 3.5 | 0.7 | 5.0 |
| Example 2 | Toner 2 | 90 | +65 | 24.3 | 0.82 | 3.6 | 0.8 | 13.3 |
| Example 3 | Toner 3 | 110 | +65 | 25.4 | 0.81 | 3.6 | 0.7 | 3.9 |
| Example 4 | Toner 4 | 100 | +65 | 20.4 | 1.82 | 3.7 | 0.8 | 5.0 |
| Example 5 | Toner 5 | 100 | +65 | 19.9 | 2.76 | 3.5 | 0.9 | 5.2 |
| Example 6 | Toner 6 | 100 | +65 | 20.5 | 2.72 | 3.5 | 0.8 | 5.1 |
| Example 7 | Toner 7 | 100 | +65 | 20.0 | 2.75 | 3.7 | 0.8 | 5.2 |
| Example 8 | Toner 8 | 100 | +65 | 20.3 | 2.73 | 3.5 | 0.8 | 5.1 |
| Example 9 | Toner 9 | 100 | +65 | 23.1 | 0.95 | 3.4 | 0.8 | 5.0 |
| Example 10 | Toner 10 | 100 | +65 | 24.3 | 0.77 | 3.5 | 0.8 | 5.1 |
| Example 11 | Toner 11 | 100 | +65 | 21.3 | 1.73 | 3.5 | 0.7 | 5.2 |
| Example 12 | Toner 12 | 100 | +65 | 26.3 | 0.62 | 3.4 | 0.7 | 5.2 |
| Example 13 | Toner 13 | 90 | +55 | 21.3 | 1.73 | 4.7 | 0.7 | 5.0 |
| Example 14 | Toner 14 | 90 | +50 | 20.2 | 1.85 | 5.8 | 0.7 | 5.0 |
| Example 15 | Toner 15 | 95 | +45 | 18.9 | 2.02 | 8.0 | 0.8 | 5.1 |
| Example 16 | Toner 16 | 105 | +70 | 27.1 | 0.51 | 2.8 | 0.7 | 5.2 |
| Example 17 | Toner 17 | 110 | +70 | 27.6 | 0.44 | 2.5 | 0.9 | 4.9 |
| Example 18 | Toner 18 | 120 | +75 | 27.9 | 0.35 | 1.8 | 0.8 | 5.3 |
| Example 19 | Toner 19 | 100 | +65 | 22.4 | 1.50 | 3.7 | 0.9 | 4.9 |
| Example 20 | Toner 20 | 100 | +65 | 18.7 | 2.14 | 3.6 | 0.8 | 5.2 |
| Example 21 | Toner 21 | 100 | +65 | 22.2 | 1.55 | 3.6 | 0.9 | 5.1 |
| Example 22 | Toner 22 | 100 | +65 | 18.5 | 2.26 | 3.7 | 0.7 | 5.3 |
| Example 23 | Toner 23 | 110 | +70 | 26.9 | 0.56 | 2.2 | 0.8 | 4.8 |
| Example 24 | Toner 24 | 120 | +75 | 27.2 | 0.49 | 1.7 | 0.9 | 5.0 |
| Example 25 | Toner 25 | 90 | +55 | 21.5 | 1.72 | 5.8 | 0.8 | 5.3 |
| Example 26 | Toner 26 | 100 | +65 | 20.0 | 1.99 | 3.5 | 0.9 | 5.2 |
| Example 27 | Toner 27 | 100 | +65 | 26.9 | 0.56 | 5.1 | 0.9 | 5.2 |
| Example 28 | Toner 28 | 100 | +65 | 27.3 | 0.47 | 8.0 | 0.7 | 5.0 |
| Example 29 | Toner 29 | 100 | +55 | 22.9 | 1.42 | 2.0 | 0.8 | 5.0 |
| Example 30 | Toner 30 | 100 | +45 | 19.1 | 2.01 | 1.5 | 0.7 | 5.1 |
| Example 31 | Toner 31 | 100 | +65 | 23.6 | 1.30 | 3.4 | 2.2 | 14.8 |
| Example 32 | Toner 32 | 100 | +65 | 24.2 | 1.14 | 3.3 | 1.3 | 10.3 |
| Example 33 | Toner 33 | 100 | +65 | 24.5 | 1.12 | 3.5 | 1.5 | 12.2 |
| Example 34 | Toner 34 | 100 | +65 | 24.0 | 1.15 | 3.3 | 0.9 | 5.2 |
| Example 35 | Toner 35 | 100 | +65 | 26.7 | 0.63 | 3.4 | 0.8 | 5.0 |
| Example 36 | Toner 36 | 100 | +65 | 23.7 | 1.29 | 3.5 | 2.1 | 14.7 |
| C.E. 1 | Comparative toner 1 | 100 | +65 | 18.3 | 3.42 | 3.5 | 0.8 | 5.1 |
| C.E. 2 | Comparative toner 2 | 100 | +65 | 18.1 | 3.50 | 3.4 | 0.8 | 5.2 |
| C.E. 3 | Comparative toner 3 | 100 | +65 | 17.7 | 3.55 | 3.3 | 0.8 | 5.0 |
| C.E. 4 | Comparative toner 4 | 100 | +65 | 17.8 | 3.51 | 3.5 | 0.7 | 5.0 |
| C.E. 5 | Comparative toner 5 | 100 | +65 | 17.2 | 4.29 | 3.5 | 0.9 | 5.3 |
| C.E. 6 | Comparative toner 6 | 90 | +65 | 23.6 | 1.02 | 3.5 | 0.9 | 20.0 |
| C.E. 7 | Comparative toner 7 | 125 | +65 | 23.8 | 1.01 | 3.3 | 0.7 | 3.8 |
| C.E. 8 | Comparative toner 8 | 100 | +65 | 15.7 | 6.09 | 3.6 | 0.9 | 5.2 |
| C.E. 9 | Comparative toner 9 | 100 | +65 | 16.7 | 5.88 | 3.6 | 0.8 | 5.1 |
| C.E. 10 | Comparative toner 10 | 90 | +30 | 15.0 | 6.21 | 10.2 | 2.2 | 14.6 |
| C.E. 11 | Comparative toner 11 | 125 | +75 | 28.1 | 0.33 | 1.3 | 0.7 | 4.9 |
| C.E. 12 | Comparative toner 12 | 100 | +30 | 15.3 | 6.18 | 10.5 | 2.3 | 14.9 |
| C.E. 13 | Comparative toner 13 | 100 | +65 | 16.0 | 6.05 | 3.5 | 2.2 | 14.2 |
| C.E. 14 | Comparative toner 14 | 100 | +65 | 16.2 | 6.03 | 5.2 | 2.4 | 14.5 |
| C.E. 15 | Comparative toner 15 | 100 | +65 | 15.6 | 6.07 | 3.5 | 0.9 | 5.1 |

In the table, in the evaluation of hot offset resistance, the difference is the difference between the maximum fixation temperature and the fixing onset temperature. “C.E.” indicates “Comparative Example”.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-159095, filed Sep. 13, 2024, which is hereby incorporated by reference herein in its entirety.

What is claimed is:

1. A toner comprising a toner particle,
wherein the toner particle comprises a binder resin and an aliphatic alcohol,
the binder resin comprises a crystalline vinyl resin and an amorphous vinyl resin,
the crystalline vinyl resin comprises a monomer unit (a) represented by following Formula (1),
the amorphous vinyl resin comprises a monomer unit (b) represented by following Formula (2),
the aliphatic alcohol is a compound represented by following Formula (3), and
the toner particle comprises 100 to 10,000 ppm of the aliphatic alcohol based on a mass of the binder resin: 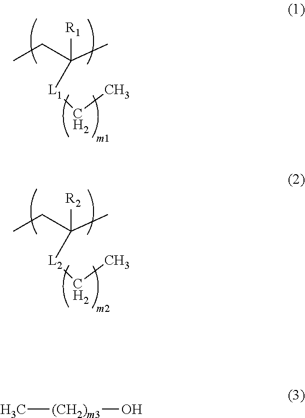
in Formula (1), R₁ represents a hydrogen atom or a methyl group, L₁ represents a single bond, an ester bond or an amide bond, and m1 represents an integer of 15 to 29,
in Formula (2), R₂ represents a hydrogen atom or a methyl group, L₂ represents a single bond, an ester bond or an amide bond, and m2 represents an integer of 0 to 13, and
in Formula (3), m3 represents an integer of 15 to 29.

2. The toner according to claim 1, wherein the toner particle comprises 100 to 6,000 ppm of the aliphatic alcohol based on the mass of the binder resin.

3. The toner according to claim 1, wherein a content of the amorphous vinyl resin based on the mass of the binder resin is 25.0 to 95.0 mass %.

4. The toner according to claim 1, wherein the m1 and the m3 satisfy following Formula (4).
$$\vert m 1 - m 3 \vert \leq 2 \qquad ( 4 )$$

5. The toner according to claim 4, wherein the m2 and the m3 satisfy following Formula (5).
$$\vert m 2 - m 3 \vert \geq 6 \qquad ( 5 )$$

6. The toner according to claim 1, wherein a content of the monomer unit (a) represented by Formula (1) in the crystalline vinyl resin is 5.0 to 100.0 mass %.

7. The toner according to claim 1, wherein a content of the crystalline vinyl resin based on the mass of the binder resin is 5.0 to 75.0 mass %.

8. The toner according to claim 1, wherein the m2 represents an integer of 3 to 13.

9. The toner according to claim 1, wherein the amorphous vinyl resin comprises 20.0 to 90.0 mass % of monomer units derived from styrene.

10. The toner according to claim 1, wherein the toner particle is a toner particle having a core-shell structure comprising a core particle and a shell formed on a surface of the core particle.

11. The toner according to claim 10, wherein
the shell is an amorphous resin, and
when a SP value of the amorphous resin of the shell is SP_{S} (J/cm³)^{0.5}, and a SP value of the crystalline vinyl resin is SP_{A} (J/cm³)^{0.5},
the SP_{S} and the SP_{A} satisfy following Formula (6).
$${SP}_{S} - {SP}_{A} \leq 5. \qquad ( 6 )$$
